(19) United States
(12) Patent Application Publication
(10) Pub. No.: US 2008/0167883 A1
(43) Pub. Date: Jul. 10, 2008

(54) Method and System for Monitoring and Protecting Real Estate Title (Ownership) Against Fraudulent Transaction (Title Theft) and Mortgage Fraud

(76) Inventor: Ramin Thavildar Khazaneh, Richmond Hill (CA)

Correspondence Address: Ramin Thavildar Khazaneh, 14 Crossroads Drive, Richmond Hill, ON, L4E 5C9, omitted

(21) Appl. No.: 11/620,404

(22) Filed: Jan. 5, 2007

(51) Int. Cl. G06Q 99/00

(52) U.S. Cl. 705/1

(57) ABSTRACT

A method for monitoring and protecting a designated real estate Title (Deed/Transfer) against title theft, fraudulent transaction, mortgage fraud includes process and steps of compiling selected data records associated with a designated real estate Title from plurality of predefined sources and storing the compiled data into an associated file within a computer database, number referencing stored selected data to further facilitate confirmation and authentication of the data records, execute monitoring process for an authenticated Title by preparing and registering security Charge/Mortgage on the Title, Issue transaction permit code, registering with local and national lender data base, Mortgage default insurers and Title insurance companies as protected Title, protect an authenticated Title from fraudulent transaction, mortgage fraud and illegal activity by further verifying transactional data of the requesting party with the stored authenticated data, stop transaction on detection of data discrepancies, issue transaction completion permit and discharge registered security charge by obtaining consistency in obtained data records. A system comprising of confirmation, authentication and verification algorithm and ID validation hardware components. The system further includes a computer database for storing data records, computer software to validate ID cards, reference number data records, execute confirmation, authentication and verification algorithm and issue transaction completion permit/Termination warning and security charge/discharge documents.

### BACKGROUND OF THE INVENTION

1. Technical Field

The present invention implements a method and system for protecting Real Estate Ownership (Title) Against Fraudulent transaction performed by an unauthorized party. More specifically this invention provides a method and a system for the Real estate owners, Banks, Mortgage lenders and Title insurance companies to protect themselves against fraudulent transaction and mortgage fraud on a designated real estate Title (Ownership).

2. Description of Related Art

A transaction on real estate ownership (Title) is made of complex and extensive paper work that typically involves a Buyer, Seller, mortgage lender/finance institute, mortgage default insurance corporations, Title insurance companies, Land registry office, real estate Brokers, paralegals and lawyers.

There are numerous laws and regulations that directly or indirectly affect a real estate Ownership (title) transaction. These laws and regulations mostly affect but not limited to, Real Estate brokers, lawyers, mortgage lenders and brokers, title insurance companies and land registry office/System.

Each of the mentioned entities that are party to a real estate Transaction, perform their duties based on the related laws and regulations and also their own security checks and balances to make sure the transaction that they are part to is genuine and lawful.

In this regard, each year millions of Ownerships (Title) transactions are being performed which sums to exchange of billions of dollars between different parties.

Every year hundreds of millions of dollars are being lost in real estate industry due to fraudulent transaction (Title theft) and Mortgage fraud. Real estate Ownership Theft (Title theft) is an uprising threat to real estate industry. In fraudulent transactions (Title Theft), Real estate owners, Banks (mortgage lenders/finance companies) and title Insurance Corporation are typically the parties with extensive financial loses.

Notwithstanding to the check and balances, which are done by parties mentioned in above and the available laws and regulations in this regards, this invention will provide the real estate industry in general and specifically the home owners, Mortgage lenders and Title insurance corporation with a cohesive method and a centralized system to monitor and protect a designated real estate Ownership (Title) from fraudulent transaction (Title Theft) and mortgage fraud.

It is also appreciated that the present invention will close possible loopholes in the available laws and regulations that are governing the real estate ownership (Title) transaction in today's real estate industry, which are providing opportunities for misuse and fraud.

Thus the necessity of Universal and Centralized method and system for the prevention of title and mortgage fraud in today's real estate industry is much needed and appreciated.

The present invention fulfills this need and provides the much-needed protection in today's North America's Real estate industry.

### SUMMARY OF THE INVENTION

Method and system for protecting a designated real estate Title (Deed/Transfer) against title theft, fraudulent transaction, mortgage fraud and illegal activity from unauthorized party by implementing process and steps of compiling selected data records associated with a designated real estate Title (Deed/Transfer) from different sources and storing the compiled selected data records into a predefined file format within a computer database.

Number referencing the stored selected data to facilitate the authentication process by comparing the said data records with the identical data records obtained from owner/seller's Title (Deed/Transfer), Mortgage/charge, Tax statement documents and validated owner/seller's personal Identification information.

Further to assign owner/seller transaction permit code to an authenticated designated real estate Title (Deed/transfer) in which results to produce and issue of a security charge registration document derived from the said authenticated data record associated with the designated real estate Title (Deed/Transfer).

Register the produced security charge on an authenticated real estate Title (Deed/Transfer).

Execute monitoring process by registering the authenticated designated real estate Title (Deed/Transfer) with local and national lender data base, Mortgage default insurers and Title insurance companies and performing scheduled and random status check.

Protecting an authenticated designated real estate Title (Deed/Transfer) from fraudulent transaction, mortgage fraud and illegal activity by further verifying personal information, transactional data and transaction permit code of the party requesting the transaction with similar authenticated data stored in the associated file within the database.

Obstruct transaction completion on detection of informational and data discrepancies by notifying legal entities acting on the transaction and related law enforcement agencies of fraudulent status of the transaction.

Publish transaction completion permits to relevant parties and discharge the said registered security charge.

The present invention further includes a system which includes confirmation, authentication and verification algorithm for comparing information obtained from compiled selected data record related to a designated real estate title (Ownership/Deed/Transfer) from plurality of predefined sources for the purpose of authentication and verification process.

The system further includes a computer database for storing complied selected data records and computer software to number reference the said data records, execute the said authentication and verification algorithm and populate the authenticated and verified information into a predefine file format as transaction completion permit, security charge registration or security discharge documents for a designated real estate Title (Deed/Transfer).

It is appreciated that the present invention provides system and method to prevent real estate Title (ownership) theft from real estate owner's standpoint and mortgage fraud from mortgage lenders and title insurance's perspective.

The process of monitoring and protection in the present invention is summarized in the following five stages as illustrated in figure B.

The Authentication Process

The authentication process is the primary stage of the present invention. In this stage a method and system is used to authenticate the available data pertaining to a designated real estate property which is obtained from either a centralized on line land registry system (i.e. TARANET in the province of Ontario, Canada) and if such service is not available in Province/State/County then related data are obtained directly from the land registry office and are compared with relevant data records obtained from the owners/Sellers documents of the designated real estate property.

The Validation Process

In the verification stage a method and system is used to verify the Authenticated data records generated from the stage one by comparing the said authenticated data records with owner(s)/seller(s) personal Identification data.

In this stage the ownership (Title) of the designated real estate property is substantiate to be genuine and lawfully belonging to the ID confirmed owner(s)/Seller(s).

The Monitoring and Protection Process

The Monitoring and Protection process consists of a Three-Phase registration process, which implements a method and system to monitor and protect the Title (Ownership/Deed) of a designated real estate property against fraudulent transaction by unauthorized third party.

In the first phase the authenticated designated real estate property is registered with national database of banks/mortgage/private financial lenders, Mortgage default and Title insurance companies as protected Title (Ownership). This will enable the monitoring and protection agency to be alerted on any transactional request or activity on the protected Title (ownership) at the stage of mortgage approval.

It is appreciated that this phase of protection will provide appropriate and strong security supervision for the designated protected owner and the financial institute of being subject to fraudulent transaction and possible financial losses at the primary stages of a real estate transaction.

The second phase of monitoring and protection stage comprises of registering a second charge/Mortgage as security charge on the title (ownership) Figure E at the local land registry office or through centralized on line land registry system, where available.

It is appreciated that this phase of the present invention will facilitates the monitoring and protection agency with an effective security tool to prevent or obstruct an unauthorized transaction at the final stages of a real estate transactional process.

The third phase contains the process for issuing a transactional permit and security code for the protected designated real estate property known only to the ID validated owner of the protect Title (ownership) and the monitoring and protection agency.

The Verification Process

This stage of the present invention involves a method and system that first verifies the transactional data form the requesting party with the available authenticated data records pertaining to the protected designated real estate Title (Ownership) and subsequently verify the transaction permit security code from the transaction requesting party with the available transaction permit security code available in the monitoring and the protecting agency.

The monitoring and the protection agency by implementing the method and the system design for this stage of the present invention is enable to enforce a verification process for any requesting or pending transaction on the protected designated Title (Ownership) before authorizing the completion of the transaction, thus eliminating the possibility of an illegal or fraudulent transaction.

The Transaction Completion Process

This is the concluding stage of the present invention.

As the result of assenting verification process, the Transaction Completion stage will facilitate the monitoring and the protecting agency by means of a method and system to first prepare and issue transaction completion permit to the relevant entities involved in the transaction pertaining to the designated protected Title (Deed/ownership).

The relevant entities include but not limited to Buyer/Seller's lawyers, Mortgage or financial institute, Title insurance corporation and mortgage default insurance companies.

At the final phase of this stage the system further prepare and issues the discharge documents for the said registered security mortgage/charge.

At this point, the monitoring and protection agency have concluded a genuine and lawful transaction on a designated real estate transaction meanwhile protecting the interest of the relevant financial institute, Title insurance and the lawful owner(s) and has prevented substantial financial loses to mentioned entities.

### BRIEF DESCRIPTION OF THE DRAWINGS

1—Figure A: Block Diagram illustrating the system components requirement and minimum system support for the present invention.

2—Figure B: Block Diagram illustrating the five functional stages and the subsequent sub-stages of the present invention.

3—FIGS. C3 through C13: Flow chart diagram illustrating the data accruing process from local land registry office and related data confirmation algorithm.

4—FIGS. C14 through C27: Flow Chart diagram illustrating the data accruing process from (Owner/Seller)'s transaction documents and related data confirmation algorithm.

5—FIGS. C28 through C38: Flow Chart diagram illustrating the data accruing process from (Owner/Seller)'s Identification documents and related ID validation algorithm.

6—FIG. C39: Flow Chart diagram illustrating the authentication process of the acquired data steps and the data consistency algorithm.

7—FIG. C40: Flow Chart illustrating the monitoring and protection Process and steps of the present invention.

8—FIGS. C41 & 42: Flow Chart illustrating the verification process and steps of transaction requesting party data with available authenticated data records.

9—FIG. C43: Flow Chart illustrating the Transaction Completion process.

10—FIG. D1: System Print screen illustrating data input confirmation algorithm.

11—FIG. D2 through D5: System Print screen illustrating the system generated report for 1^{st}, 2^{nd}, 3^{rd} and 4^{th} set of confirmed reference data records.

12—FIG. D6: System Print screen illustrating the system generated report for authenticated data records sheet pertaining to a designated real estate Title.

13—Figure E: System Printout illustrating the system generated Security/Charge/Mortgage statement.

14—Figure F: Print screen illustrating the system generated report for owner/seller ID validated file.

15—FIGS. G1 & G2: System generated printout of Transaction Completion Permit and Transaction Termination Notice pertaining to a designated protected Title.

### DETAILED DESCRIPTION OF THE INVENTION

The system according to the present invention is categorized into five functional components.

1) Authentication process;

2) Validation process;

3) Monitoring and protection;

4) Verification process;

5) Transaction Completion Process.

Authentication process

The user of the Title monitoring and protection agency inputs municipality address of the designated real estate property as shown in Step (1) of FIG. C1.

The device use for this mean is a computer-inputting device such as standard keyboard, Box 5 of Figure A.

The main processing module of the system, Box 1 of Figure A, will search the database of the monitoring and protection agency for exact match of available protected real estate Titles. The data base engine used for this purpose is Microsoft Access software version 2000 of Microsoft corporation, 1 Redmond Wash. 98052-6399, USA.

If the system finds an identical property in the database then it appoints the designated property as the protected designated Title.

If the system user inputs “transaction request”, then system executes the verification process, Step (199) of FIG. C41. This stage of the present invention will be described in description for verification process. (Page 25 of this disclosure text)

If the designated property is not a protected Title, the system then searches for the available on line/centralized land registry system i.e. TARANET in the province of Ontario, Canada.

If such service is available the system by using high speed internet Modem in Box 3 of Figure A will connect to the land registry system and down load the specified data records pertaining to designated real estate property stated in Step (7A) of FIG. C4.

The system further execution of Step (55) of FIG. C13, where to as appoints the obtained specified data records as Confirmed 1 set of data references with designated reference As CRD1(n=1-9), FIG. D2.

If the system determines that the on line centralized system does not exist for the designated property then it request the system user Illustration (U) of Figure A to input the specific data records stated in Step (7) of FIG. C4 pertaining to the designated real estate Title which is obtained manually from the local land registry office.

In this mode of collecting specific data records in order to eliminate user/human error, the system further initiates a confirmation algorithm as illustrated in FIG. B1 and FIG. D1 for each specific inputted data records. The user manually inputs the specific data required in Step (7) of FIG. C4.

The device used for inputting data in this phase is a standard computer keyboard, Box 5 of Figure A.

The user inputs the first data records specified in Step (7A), FIG. C4 e.g., Municipality addresses, FIG. D1.

The system further appoints this data as RD1, Step (10) of FIG. C4. The system user next re-inputs the same data “Municipality Address” for the second time, FIG. D1. The system appoints the re-inputted data as (TRD), Step (12) FIG. C5.

The system further initiates a Confirmation Algorithm (Identical Match Algorithm), Step (13) of FIG. C5. The instrument used for this process is HTML verification module—FIG. D1—designed in Microsoft power point software of Microsoft corporation, 1 Redmond Wash. 98052-6399, USA.

If an exact match for the two inputted data is obtained, then system requests the second input data record from predefined data records (7A) e.g., “Legal Description”, Step (14) of FIG. C5.

If the inputs of the same data records are not the exact match, the system requires the user to re-input the same predefined data records, Step (18) of FIG. C6, in anticipation to obtain exact match for the inputted data records.

The system will perform data confirmation task Steps (8 to 51) of FIGS. (C4 to C13) pending all the pre selected data records in Step (7A) of FIG. C4 are confirmed and stored in storage medium in Box 1 of figure A as confirmed 1st set of data references: CRD1(n=1-9), Step (55) of FIG. C13 & FIG. D2.

The system uses Microsoft Access 2003 software of Microsoft corporation, 1 Redmond Wash. 98052-6399, USA as storage medium/database.

The HTML verification module used as confirmation algorithm at this stage of the present invention will eliminate the possibility user/human error with respect to input data pertaining to a designated real estate Title, thus resulting in to unify and error free data records needed for the next stage.

The system further request the user to input the data records pertaining to the designated real estate property from the owner(s)'s/Seller(s)'s Title (Deed/Transfer/Ownership) documents in Step (57) of FIG. C14 and FIG. D5.

The same confirmation algorithm mentioned herein is further applied to the predefined data records from the owner(s)/seller(s) obtained stated documents in Step (57) of FIG. C14.

When the system confirms all the predefined data records Steps (57 to 82) of FIG. (C14 to C19) requested in Step (57) of FIG. C14, subsequently, the system stores all the confirmed data in the storage medium/database as 2nd reference data: CRD2(n=10-14), Step(85) of FIG. C19 & FIG. D3.

Further the system request the user to enter data records as predefined in Step (87) and (108) of FIGS. C20 and C24 from the mortgage/Charge documents and Tax statement, obtained from the Owner/Seller of the designated real estate property.

The system further initiates the same confirmation algorithm for each input and re-input of data, pending the precise match of the data records stated in Step (87) and (108) and thereafter to store the result in the storage medium/database Figure A as confirmed 3rd set and 4th set of data reference: CRD3(n=15-17), Step (106) of FIG. C23 & FIG. D4 and CRD4(n=18-20), Step (127) of FIG. C27 & FIG. D5.

Steps (8) to (126) of FIGS. C3 to C27 represent confirmation algorithm for the 1^{st}, 2^{nd}, 3^{rd} and 4^{th} set of reference data.

Validation Process

The next phase of the authentication process is to validate the owner(s)/Seller(s) identification of the designated real estate property.

The system requires a valid driver's license and a second photo ID. System further employs an ID Card integrated Security check consisting of OCR, Magnetic, Barcode scanner and database management software of Box 7,8 &9 of Figure A, designed by Card Scanning Solutions 10350 Santa Monica Blvd Suite 330 Los Angeles, Calif. 90025.

The application of combination of OCR (Scanshell.net 800N), Magnetic (MagShell 900 reader) and Barcode Scanning devices of Card Scanning Solutions 10350 Santa Monica Blvd Suite 330 Los Angeles, Calif. 90025 with the database management software specifically designed for ID scanning, validation and data management offers powerful Tool for a foul proof ID validation for the Owner/Seller of the designated real estate property Figure F.

The database flexibility and capabilities, allows the system user to sort, arrange, store, retrieve, and easily export data to any other application, email and the web. The data and images can be sorted, retrieved according to various search criteria, printed in various formats. It could easily and automatically exported to any other application, email, FTP and the web.

When the drivers license and the selected second ID is validated,the system further chooses the Name, address and date of birth from the designated real estate owner(s/)Seller(s) validated ID cards as 1st set of validated ID reference data: VID1(n=21-23), Step (133) of FIG. C 29nd 2nd set of validated ID reference data: VID2(n=24-26), Step (151) FIG. C32

In the absence of a valid driver's license the system accepts one of the second ID stated in Step (134) of FIG. C29 along with a social insurance/card as the initial selected data records pertaining to the owners/sellers of the designated real estate property.

The system uses the same technology as stated in above to validate the selected second ID chosen from Step (134) of FIG. C29 and further requires:

a) The name and social insurance/security number on the SIN/SSN card as the required field input. Further the system commences the confirmation algorithm, Steps (153 to 163) of FIGS. (33 & 34) for the inputted SIN/SSN data records in anticipation of obtaining an error free selected data.

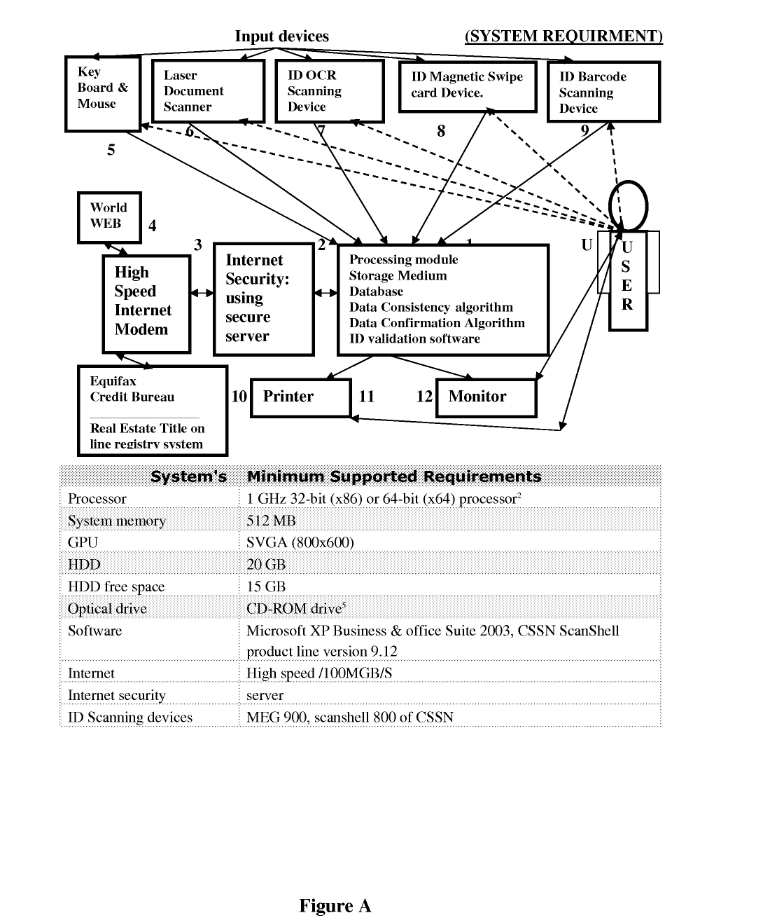

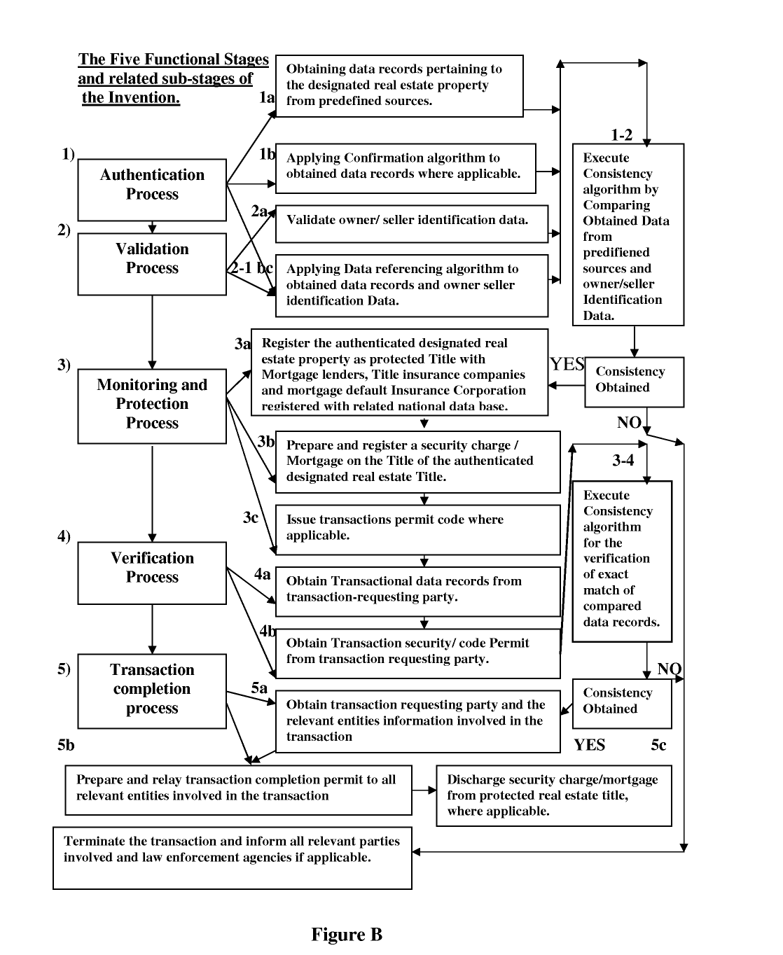

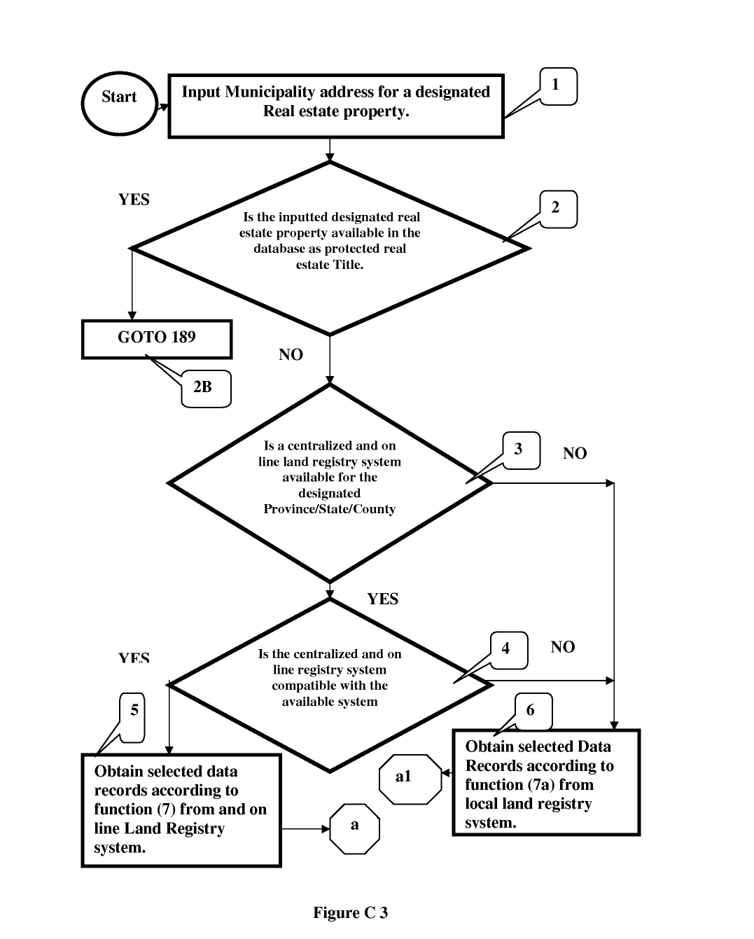

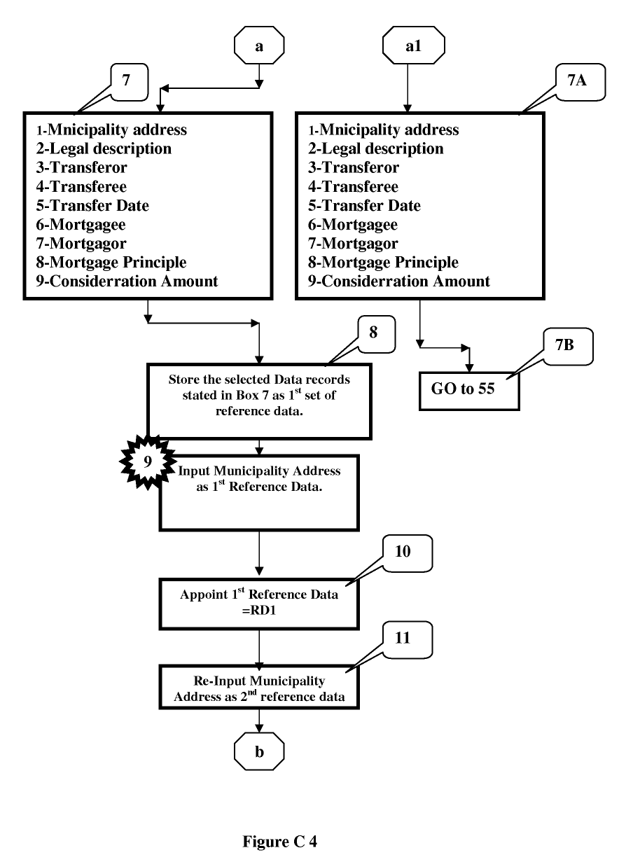

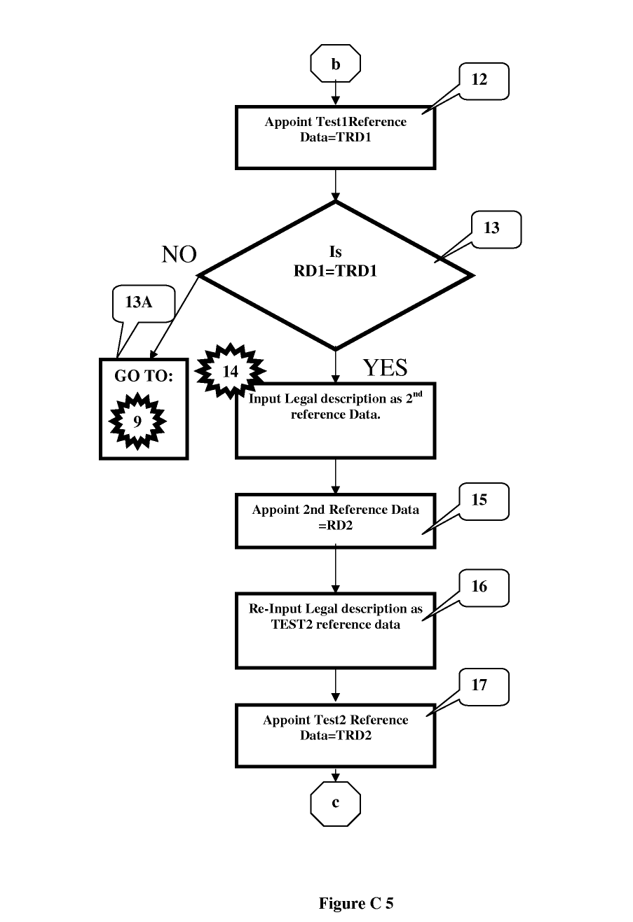

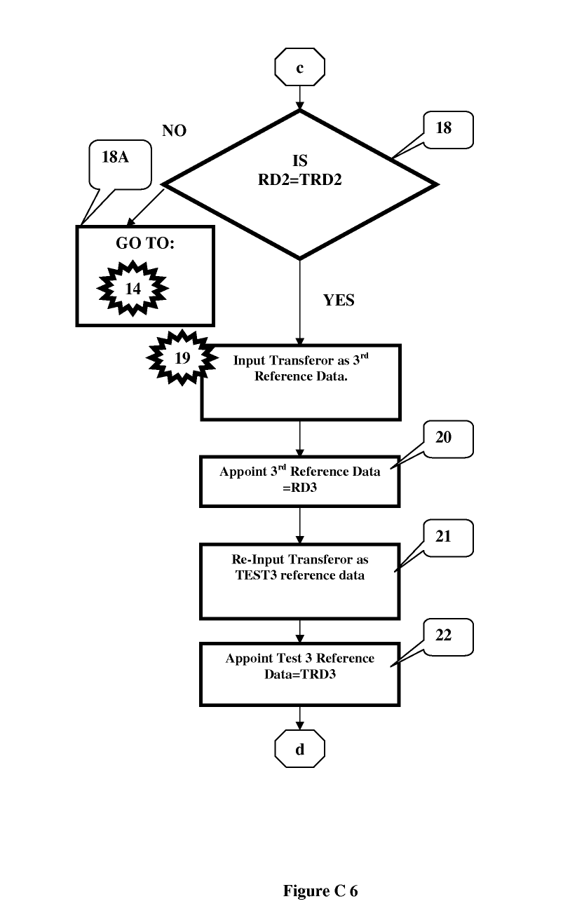

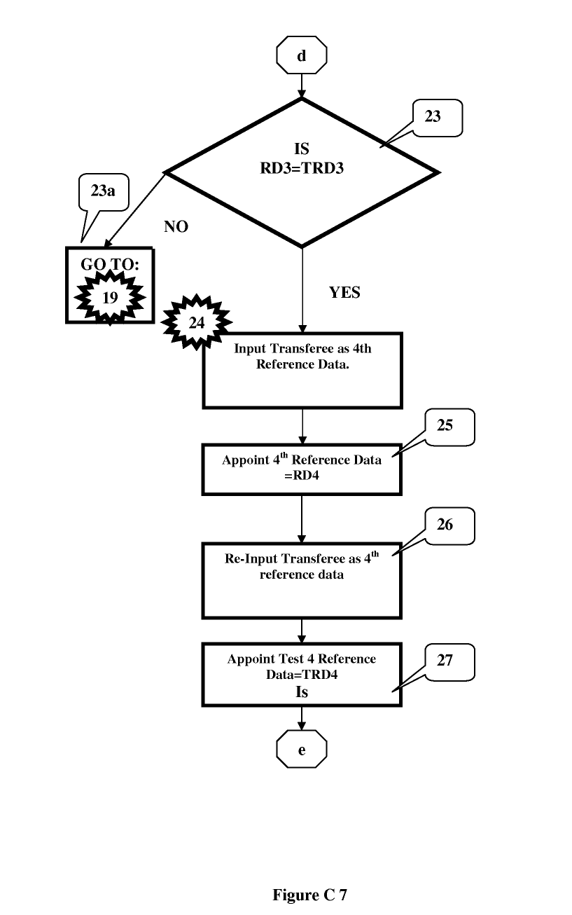

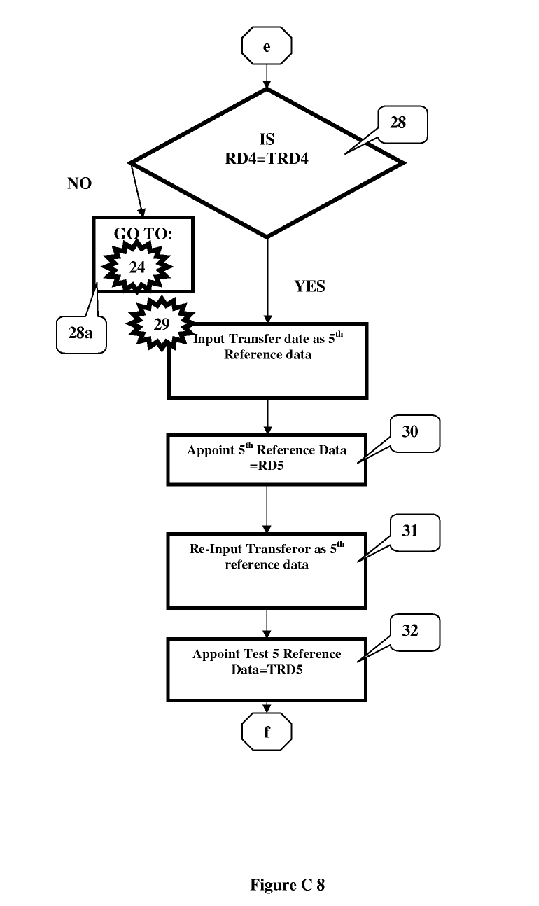

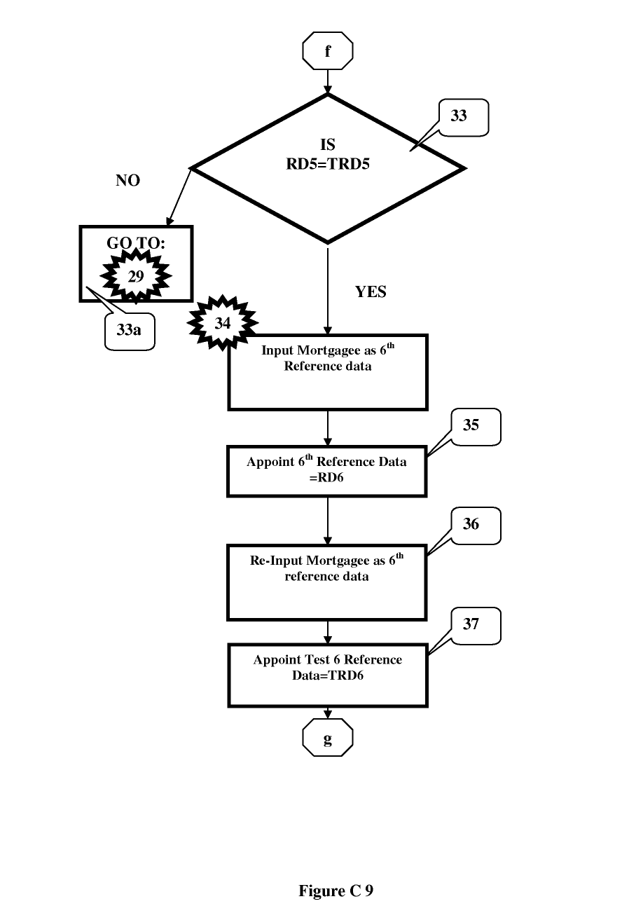

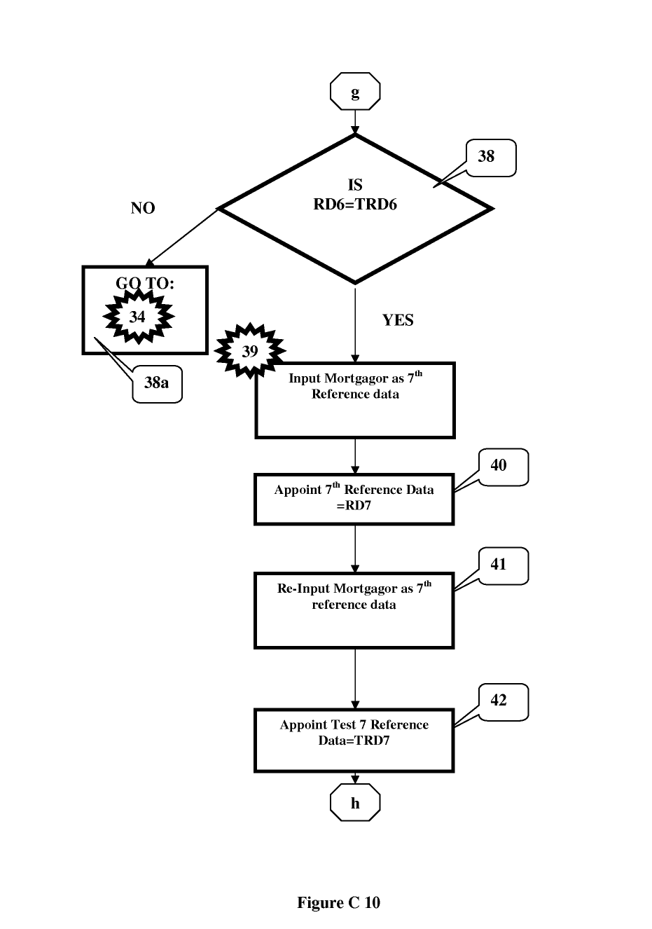

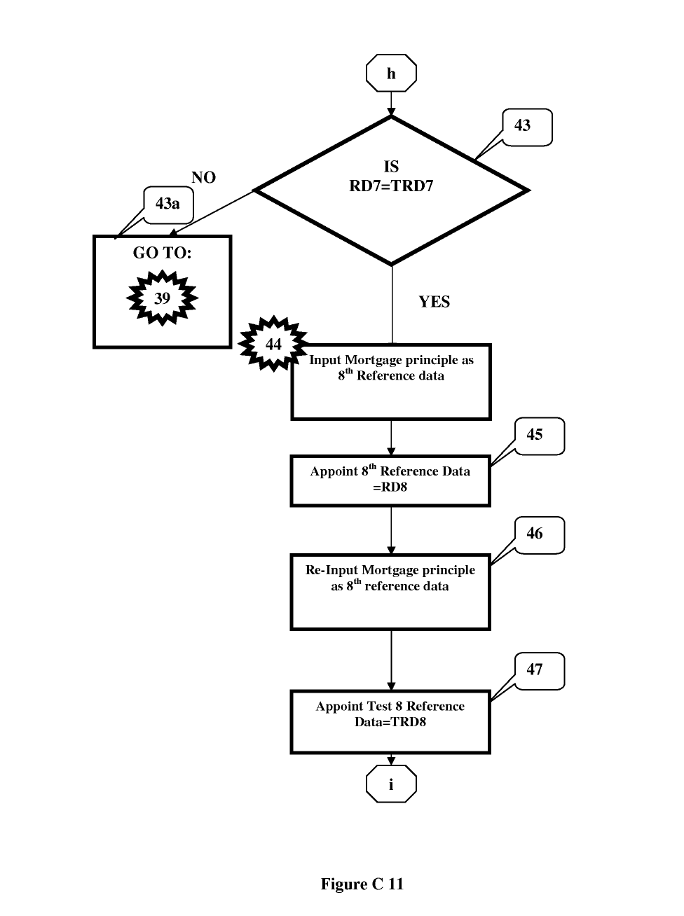

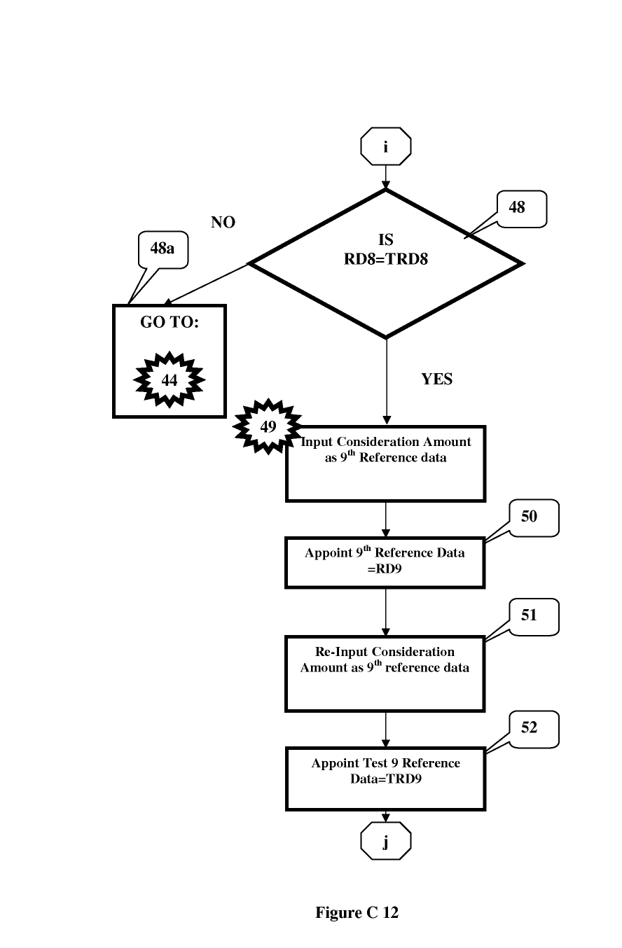

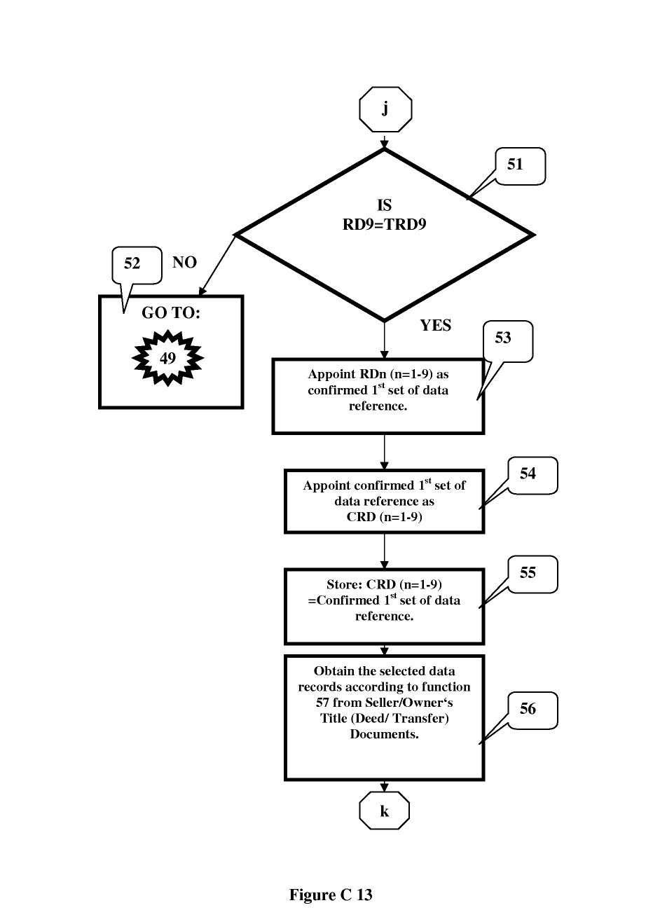

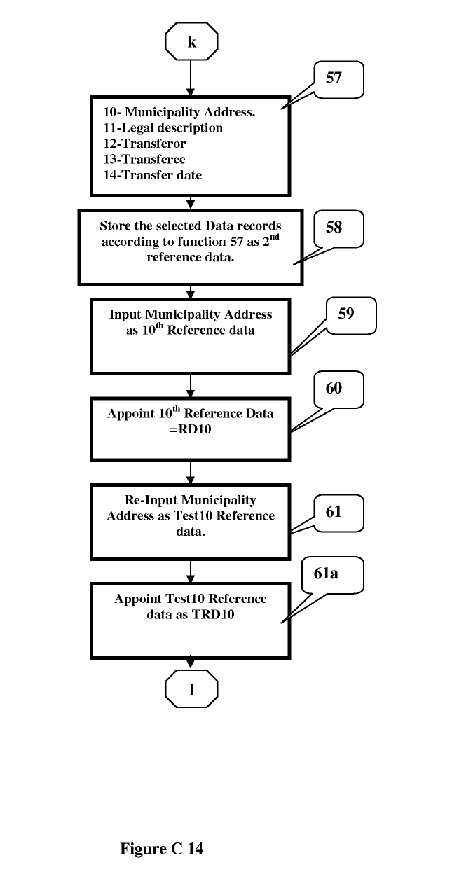

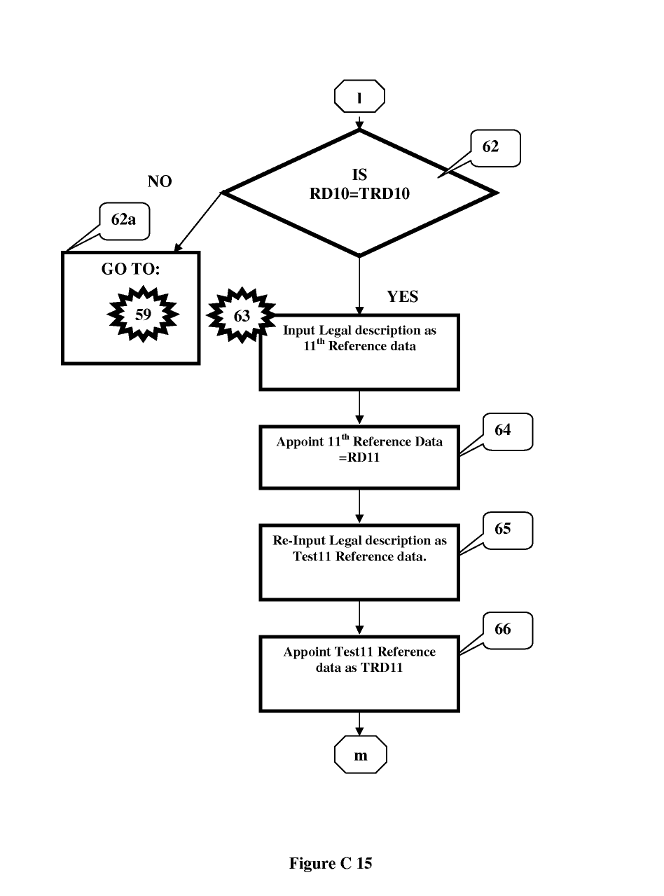

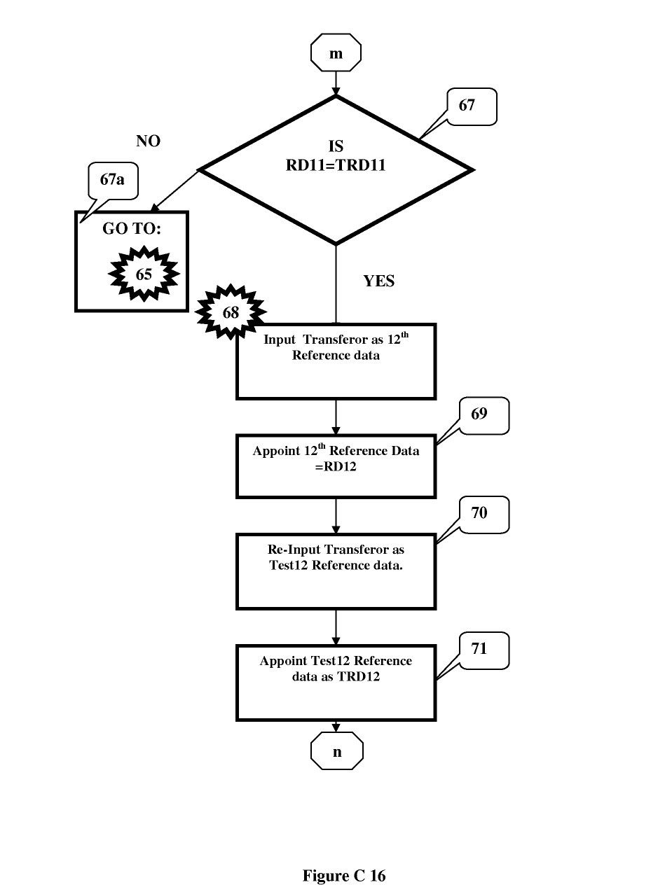

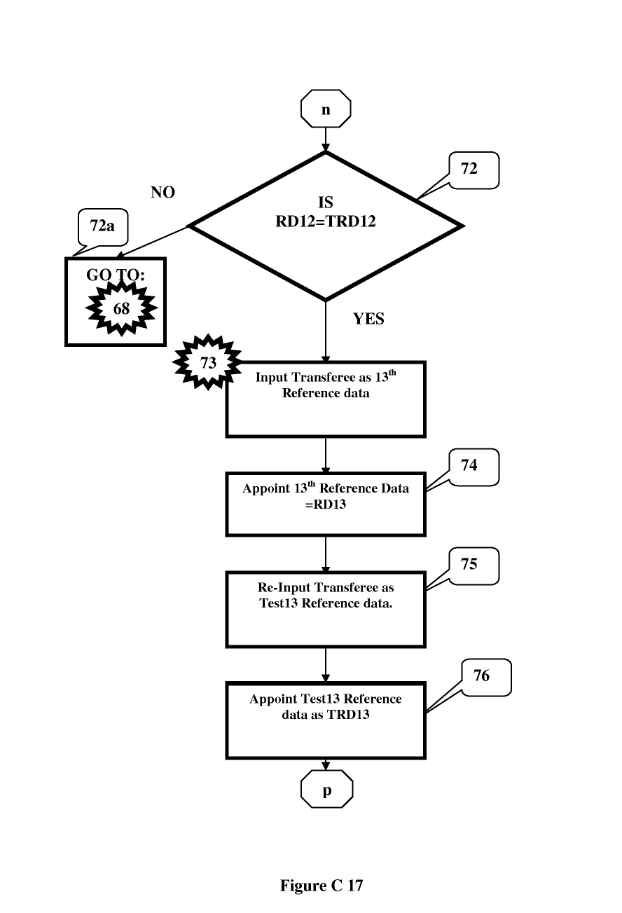

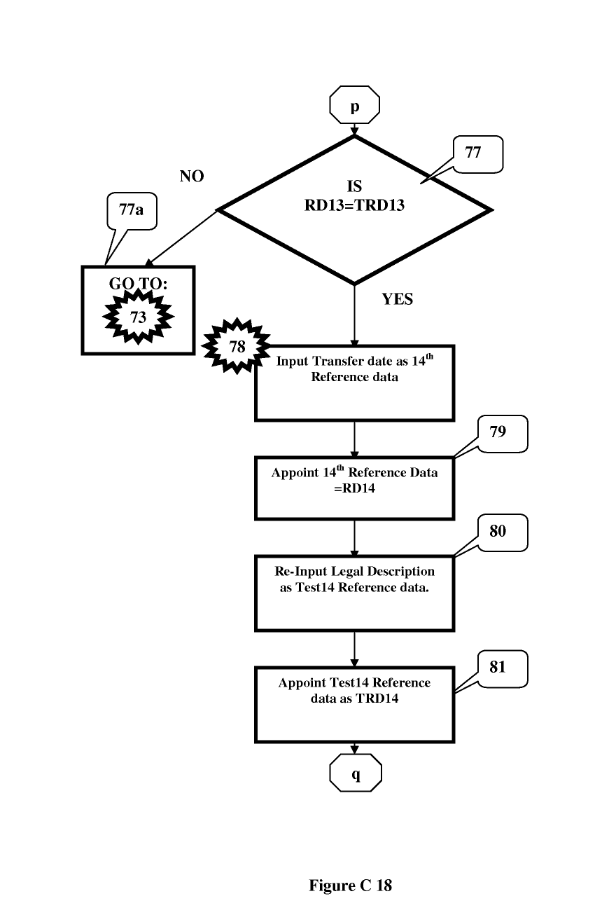

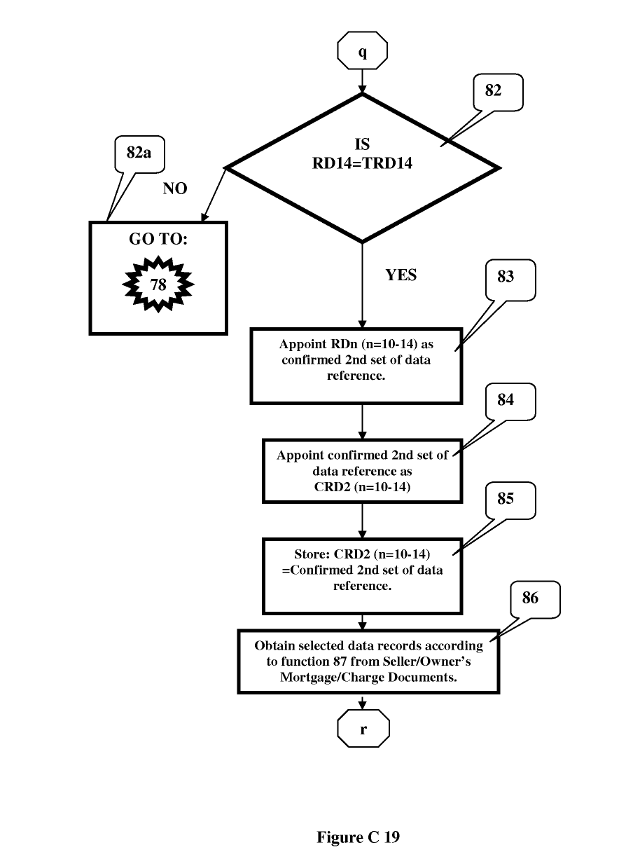

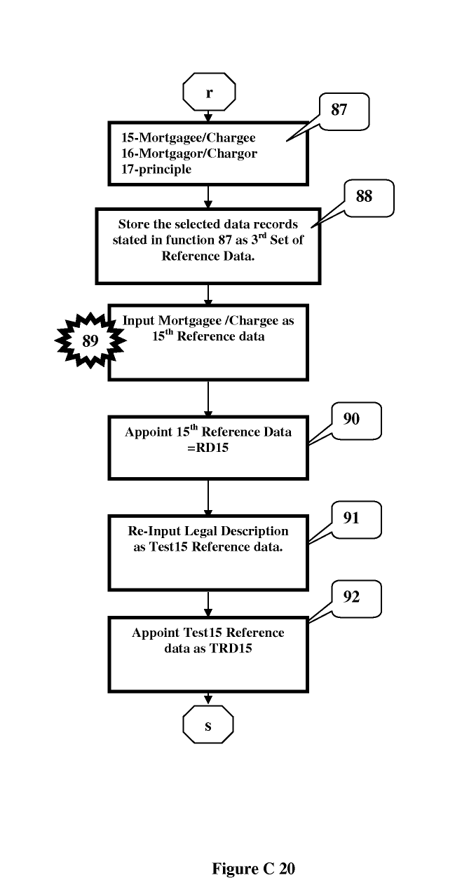

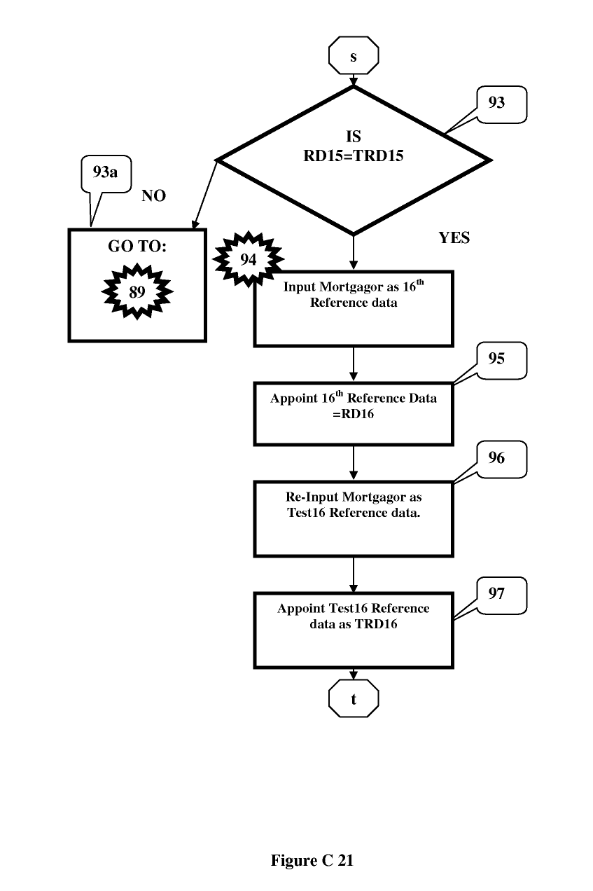

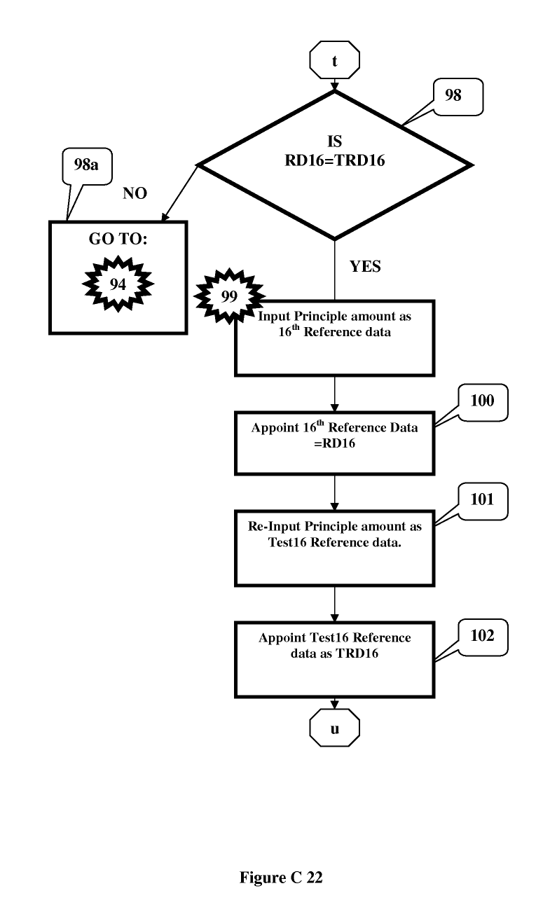

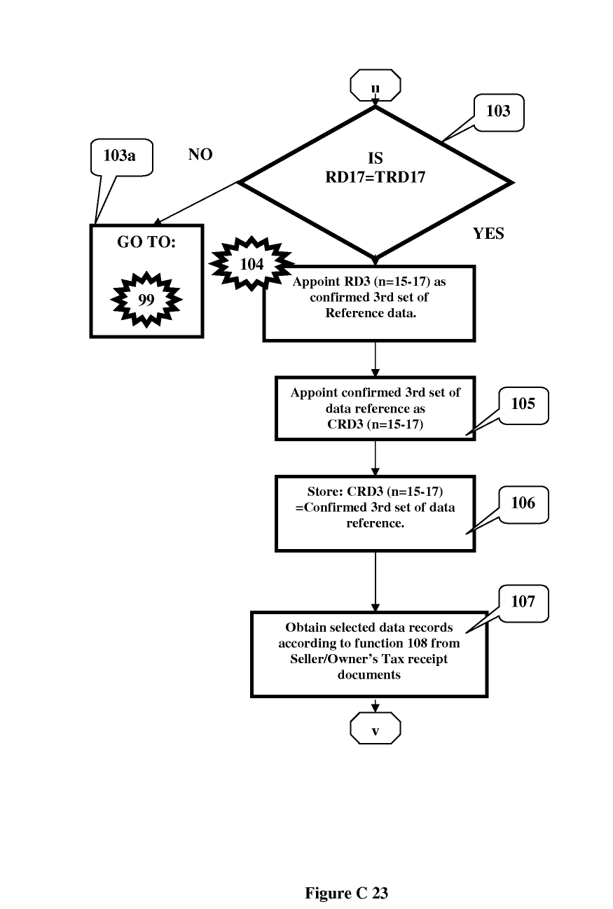

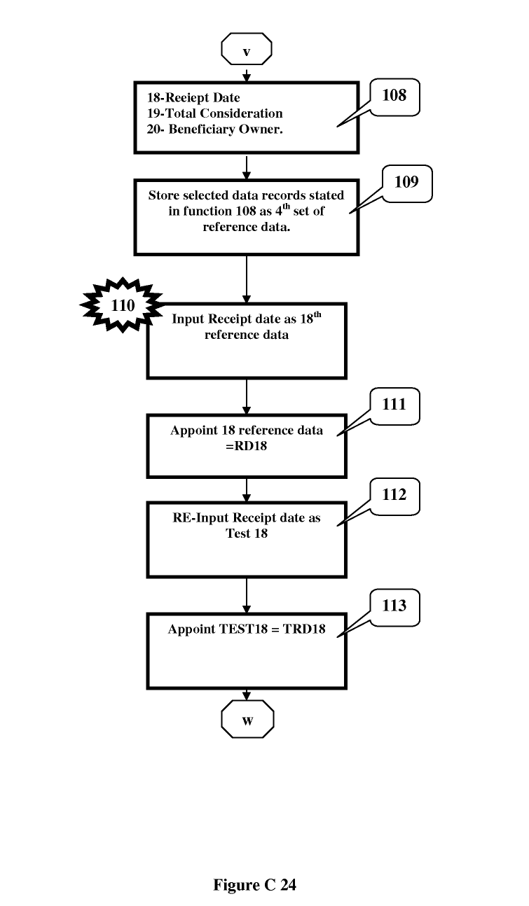

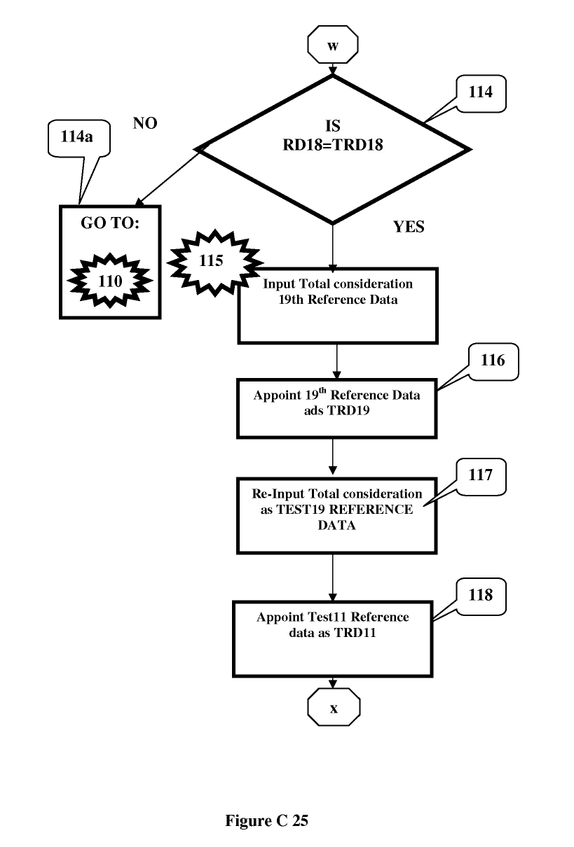

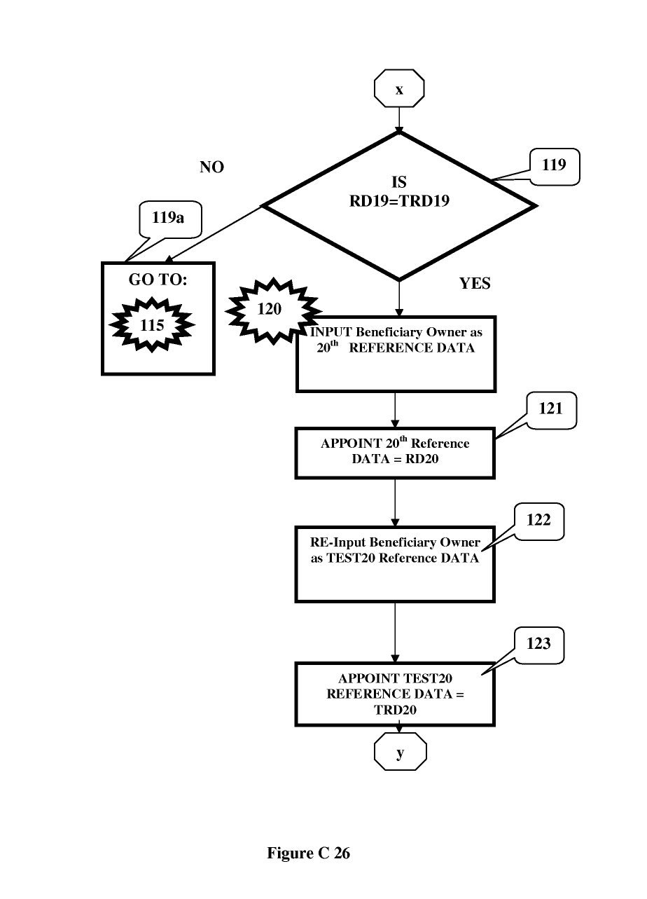

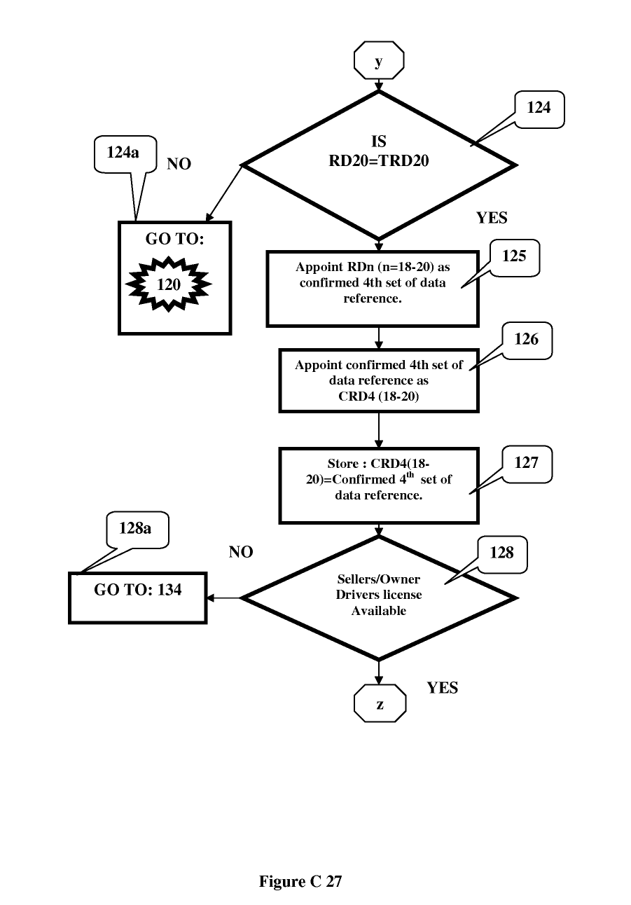

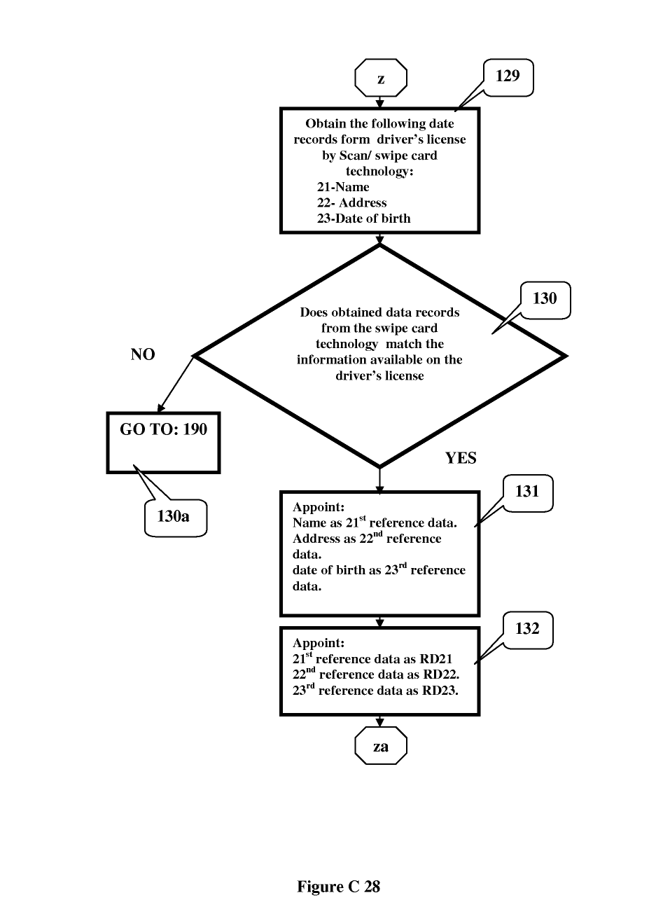

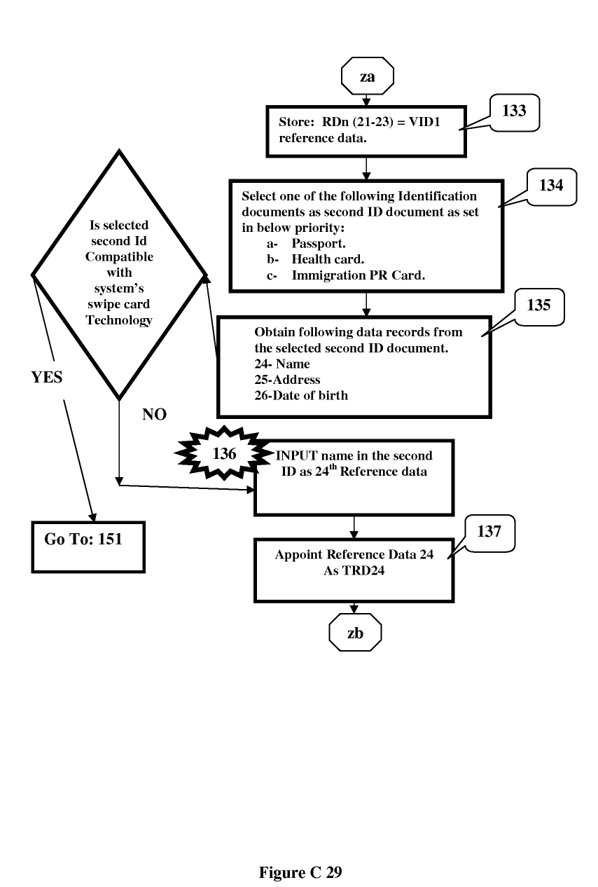

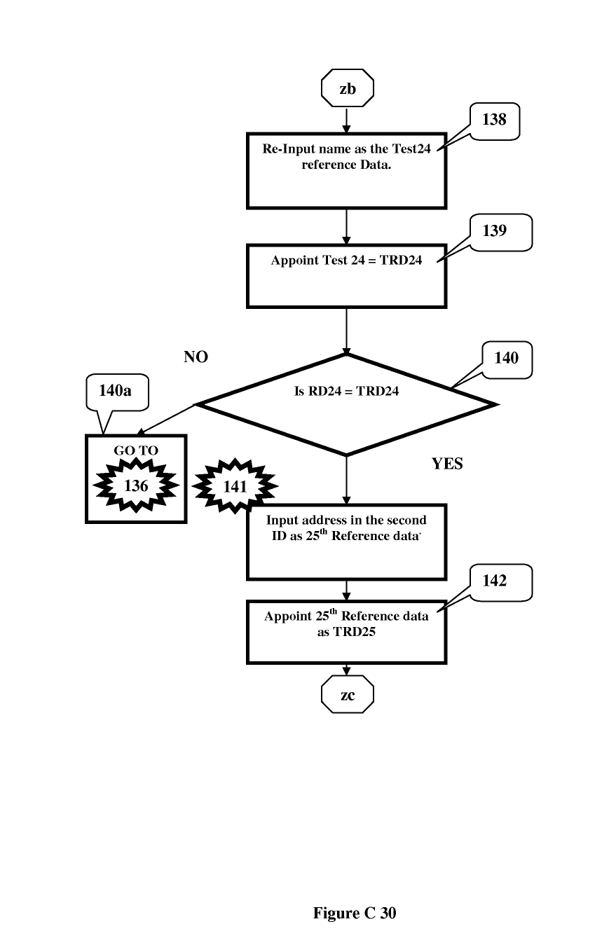

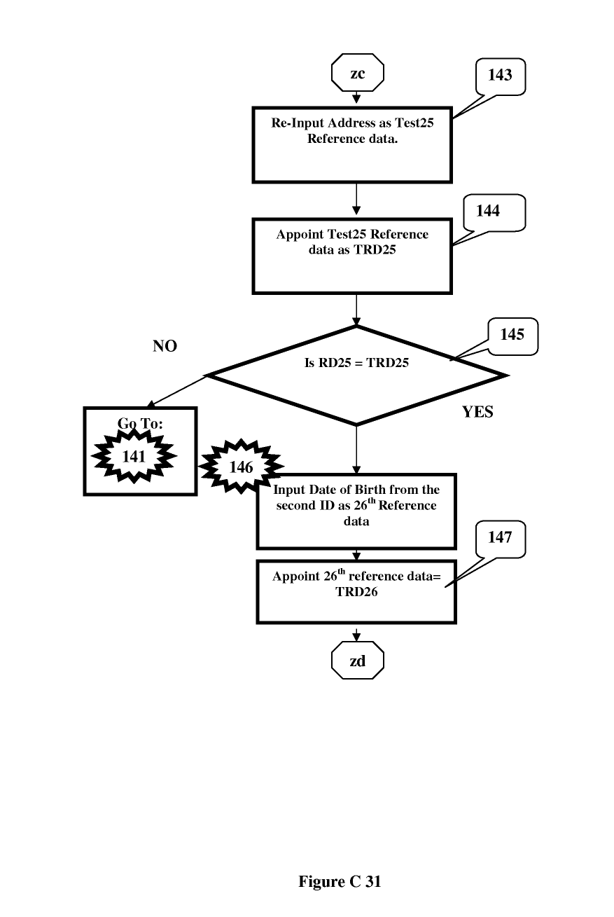

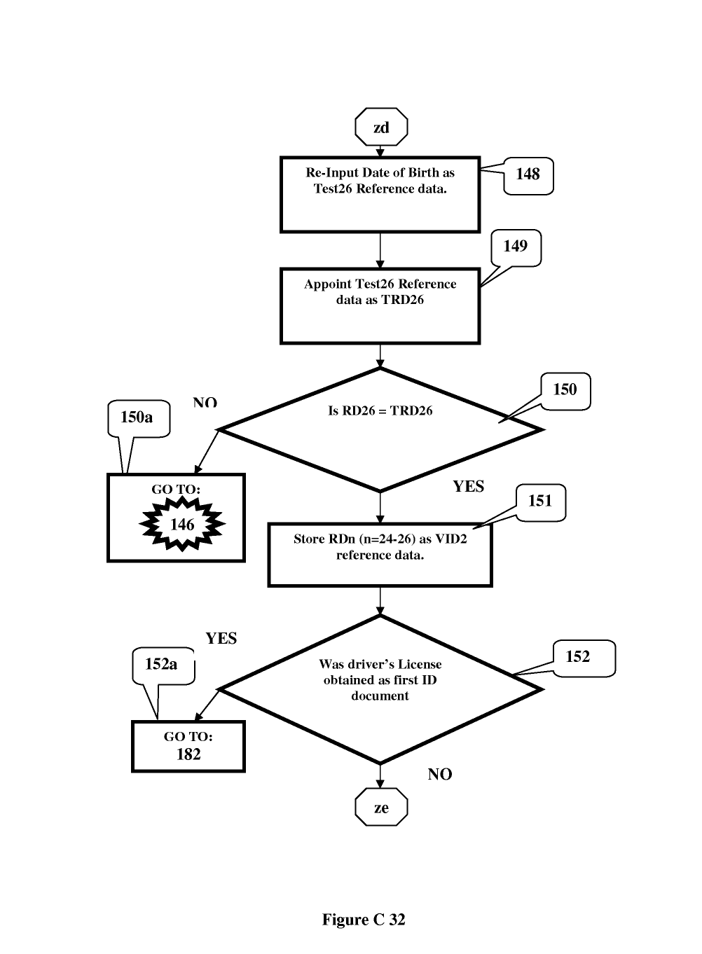

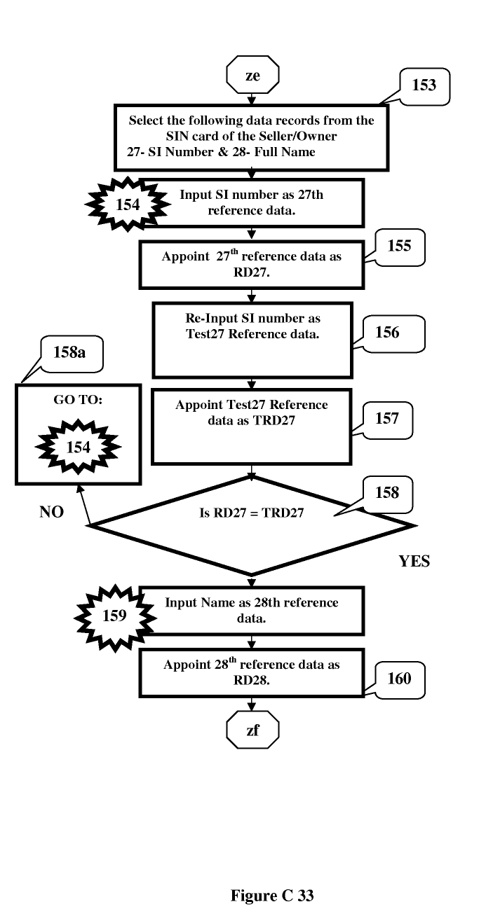

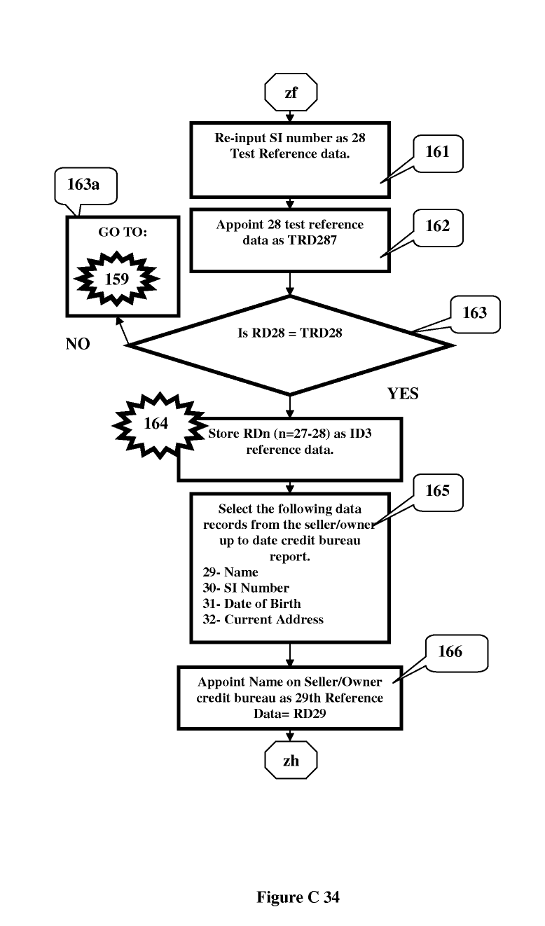

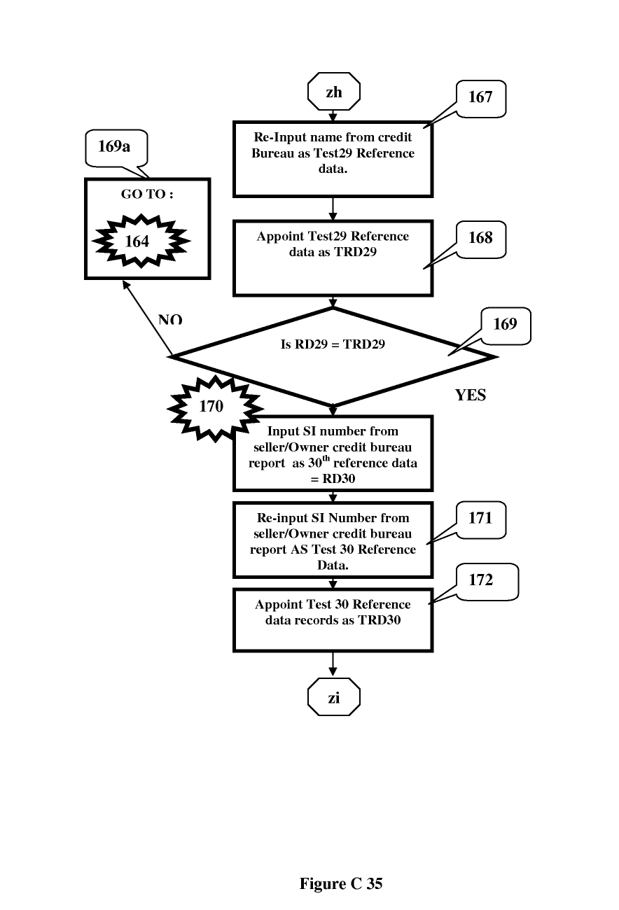

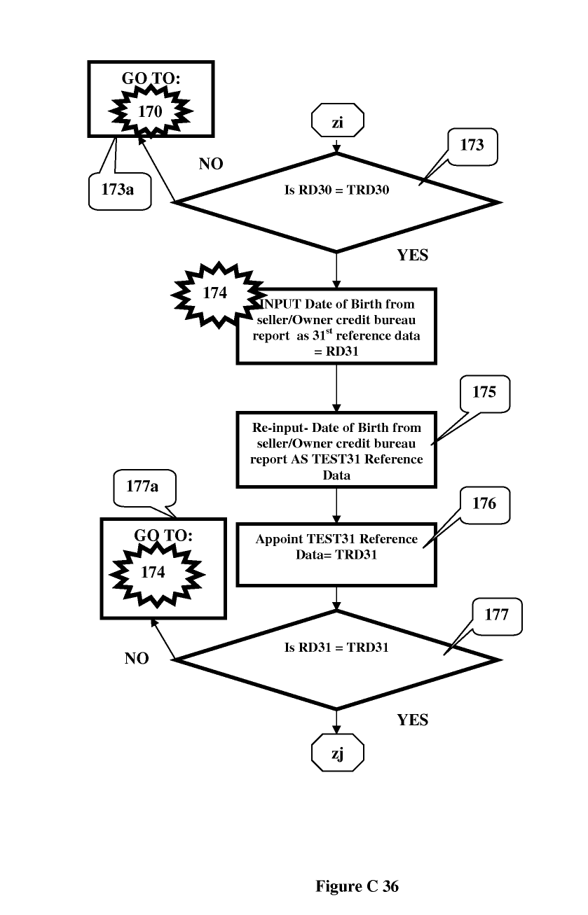

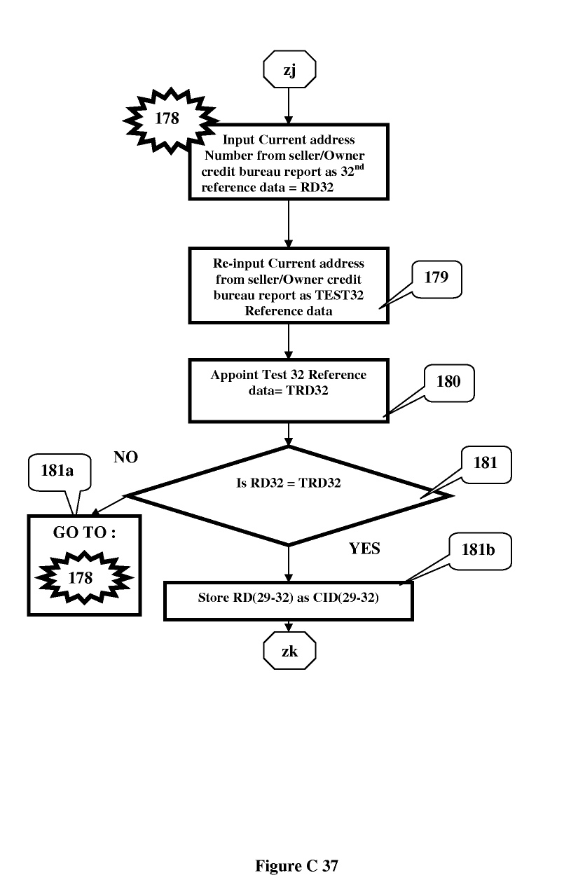

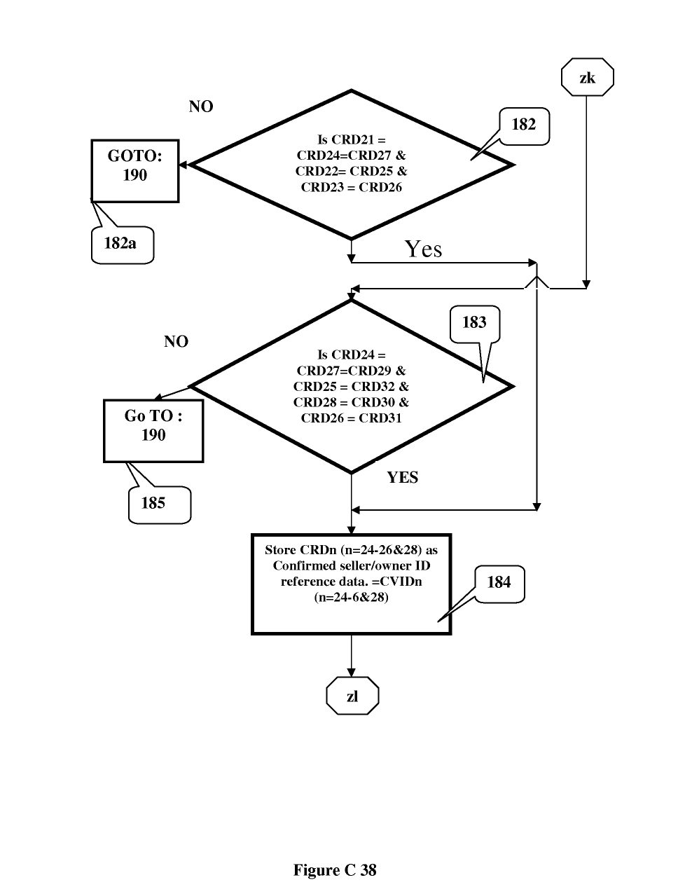

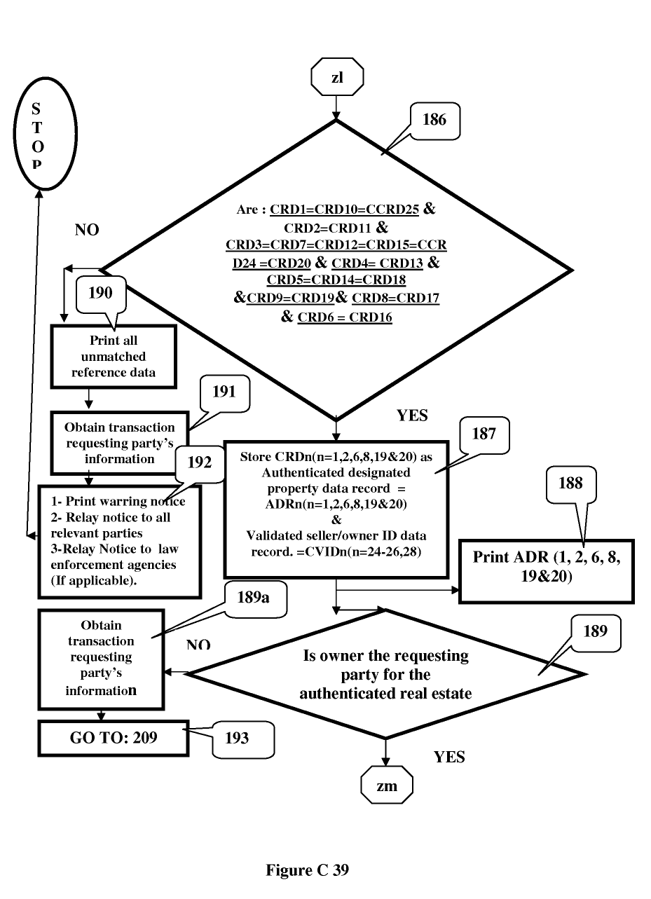

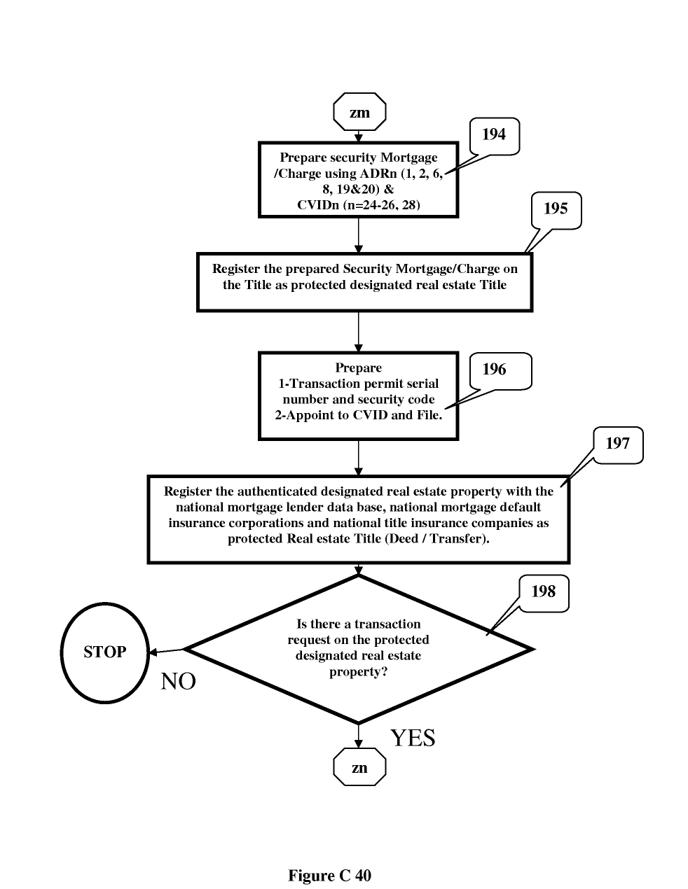

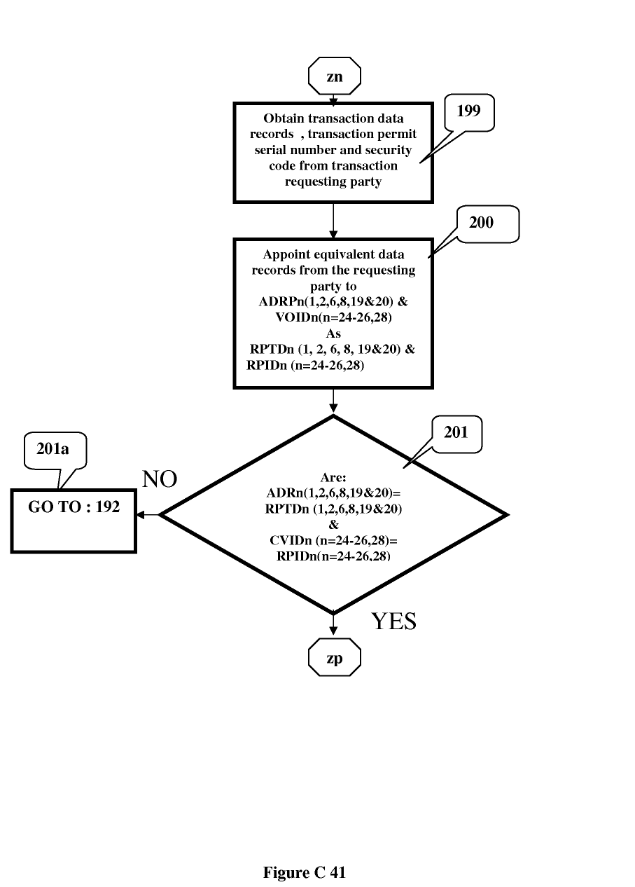

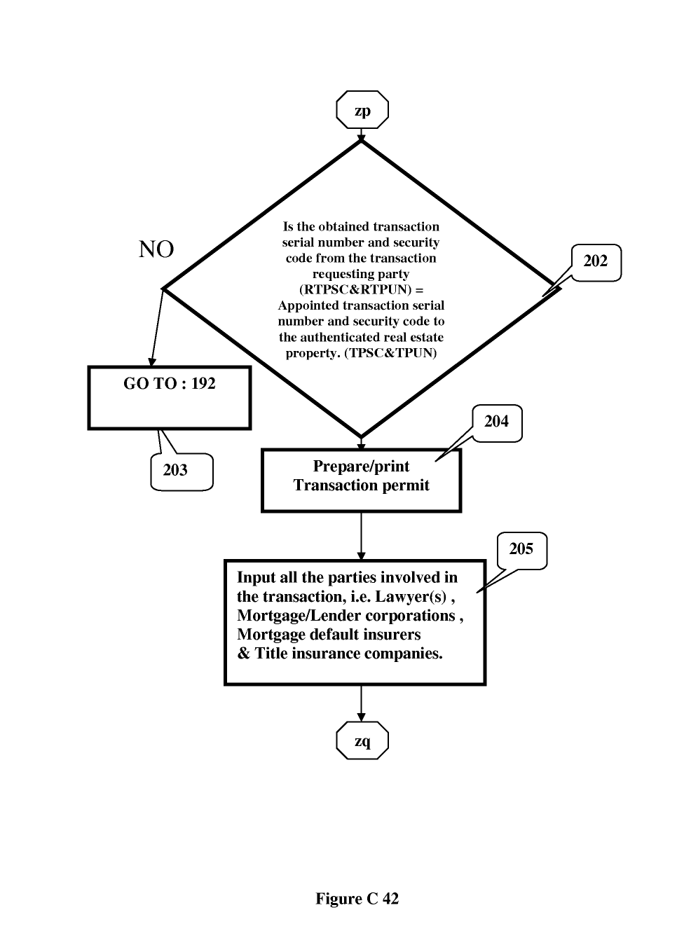

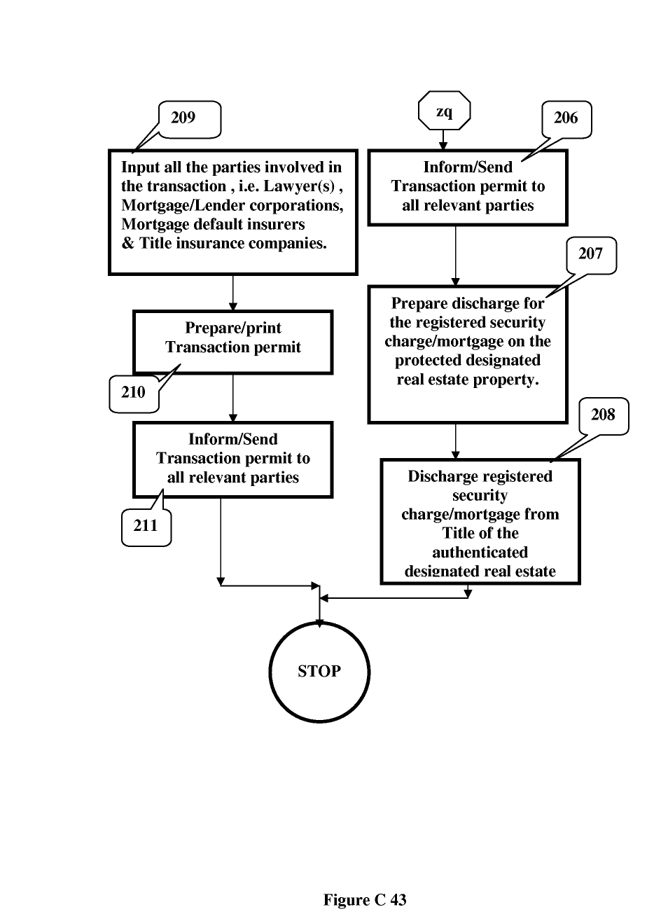

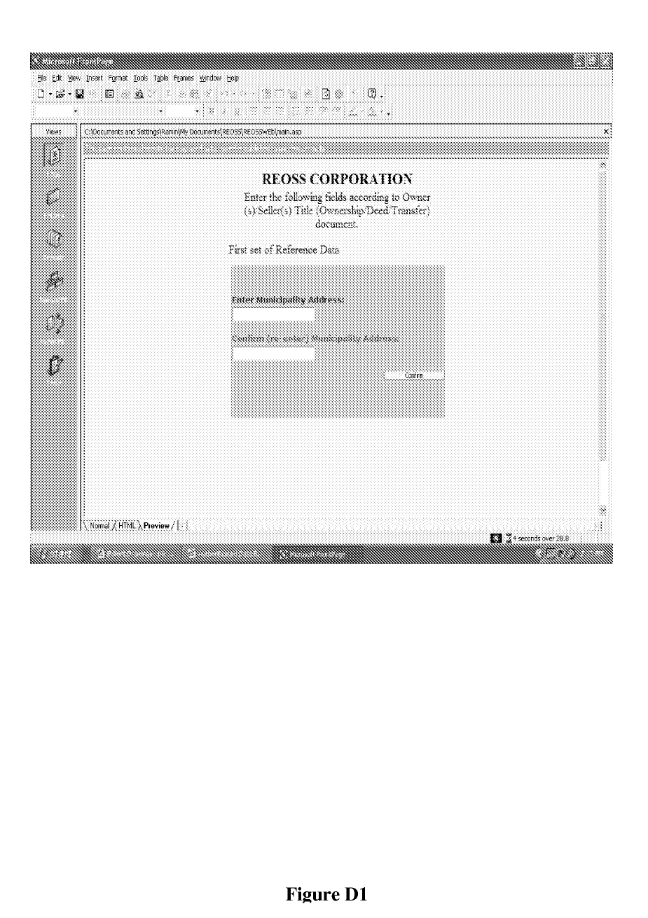

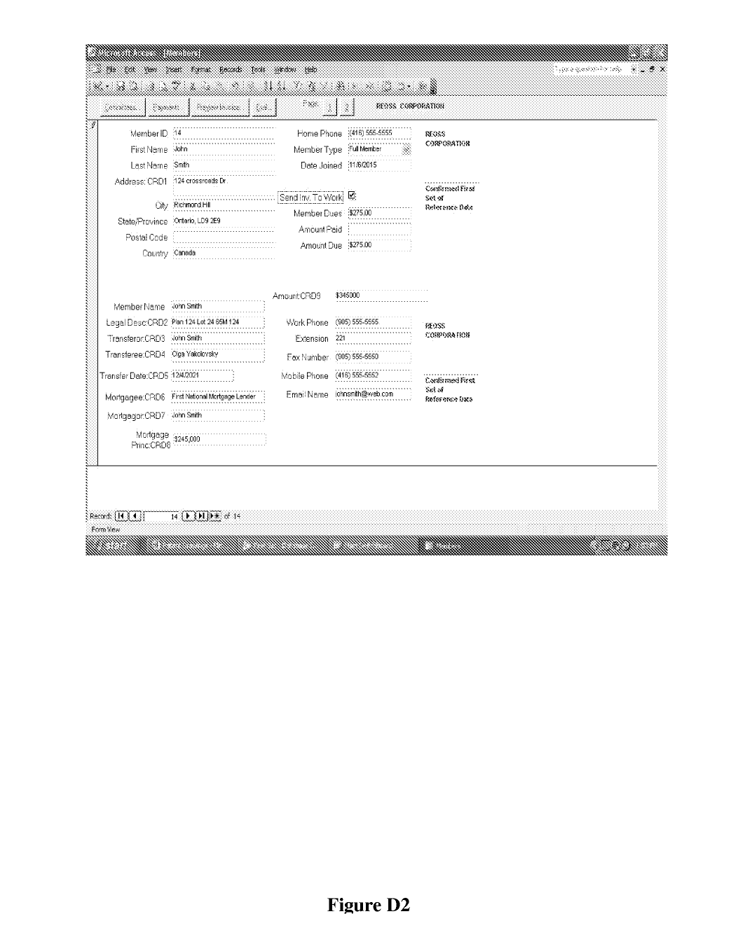

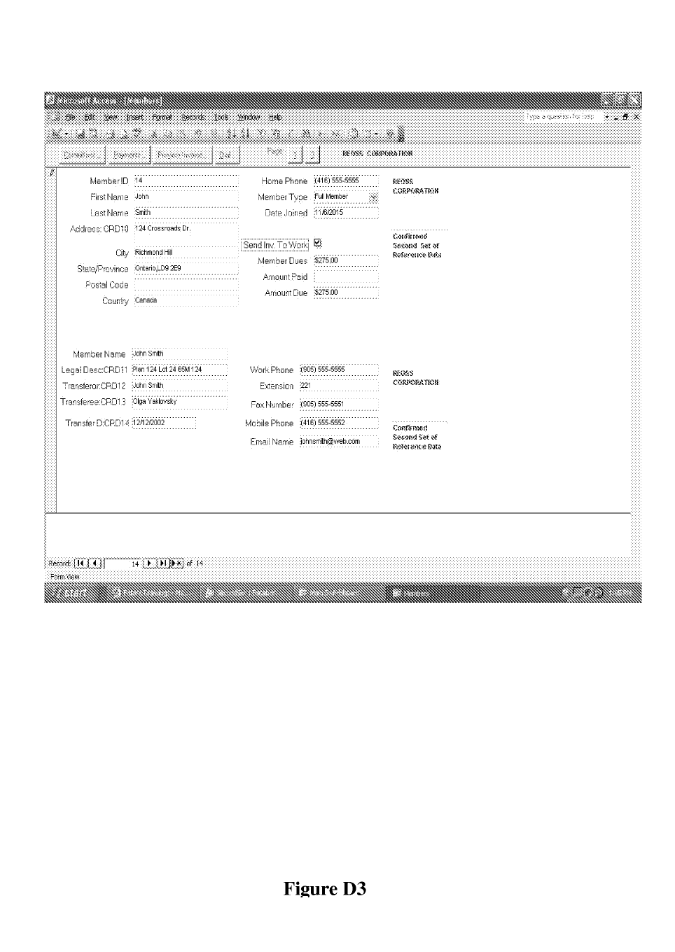

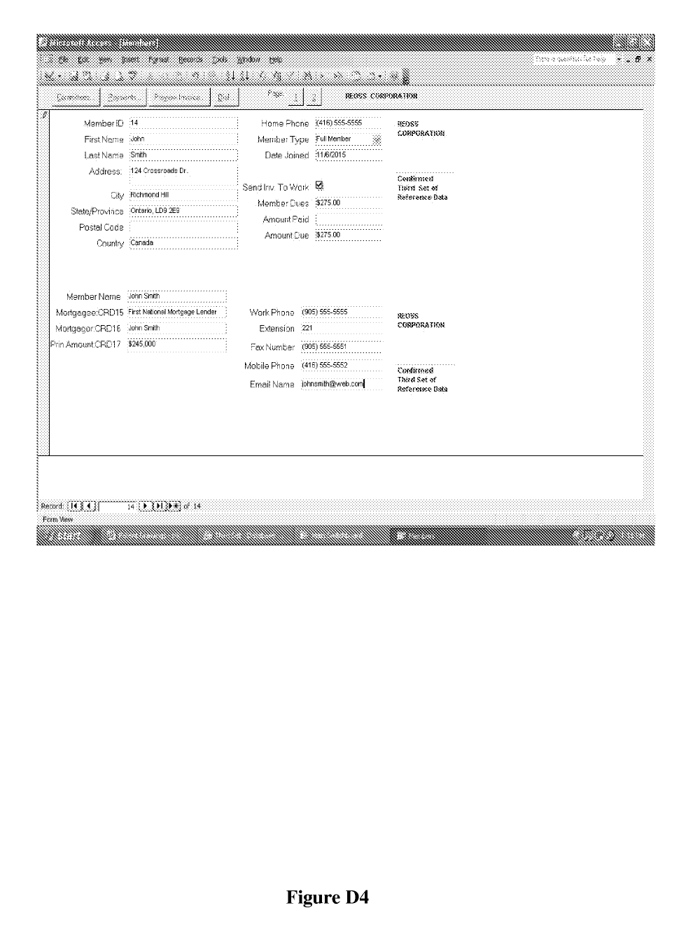

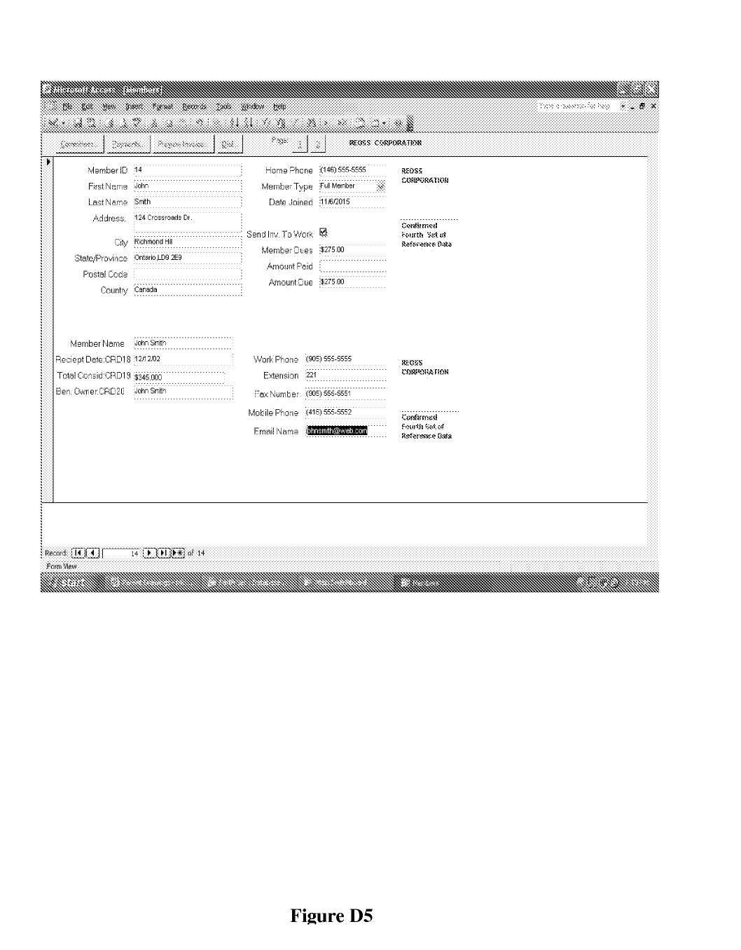

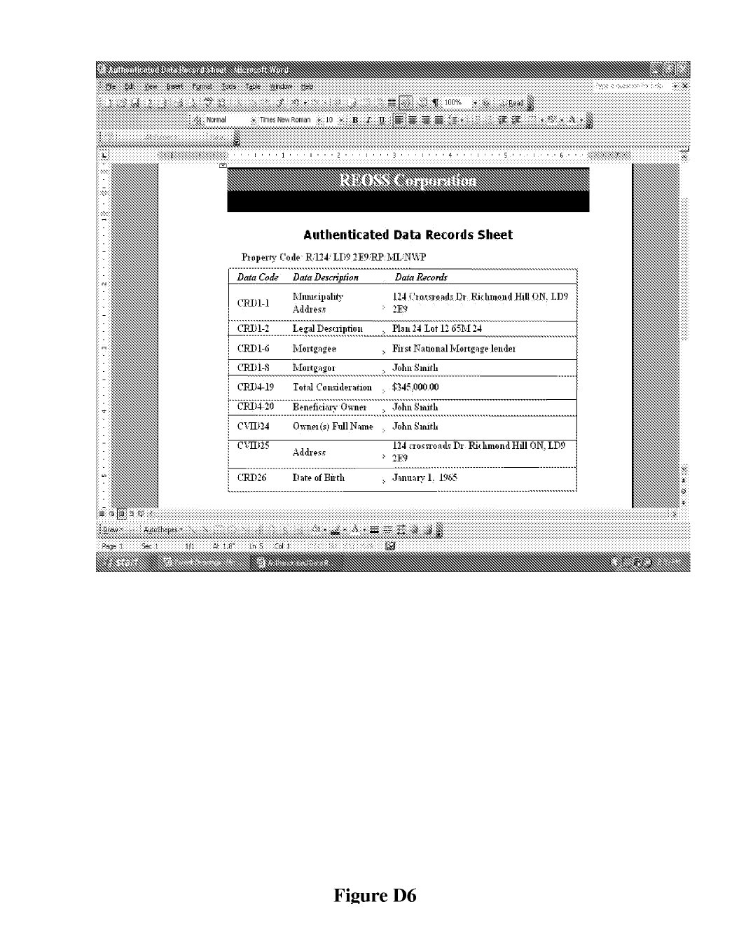

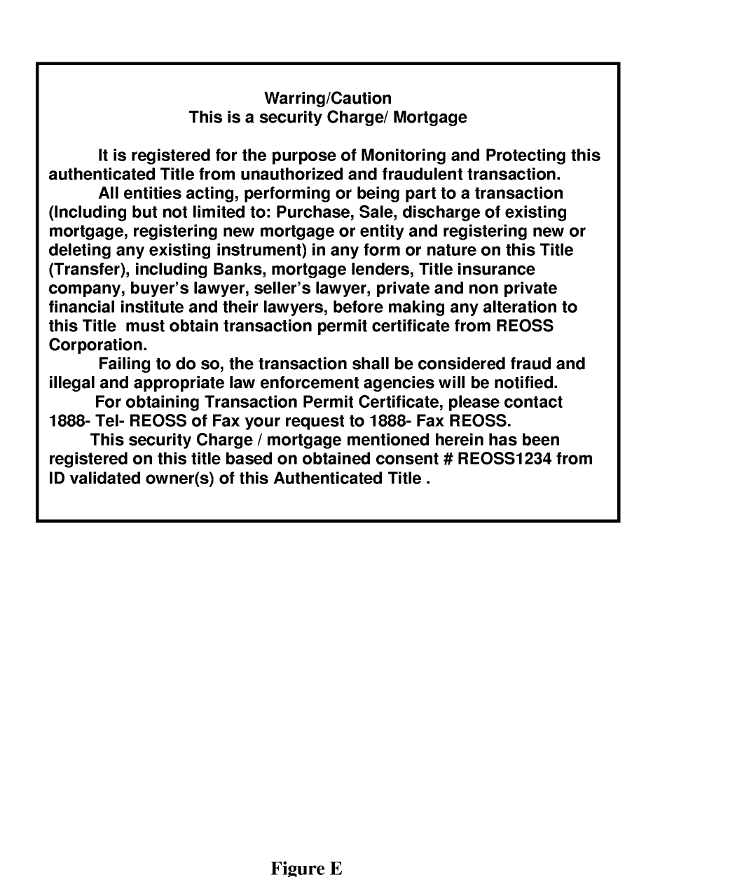

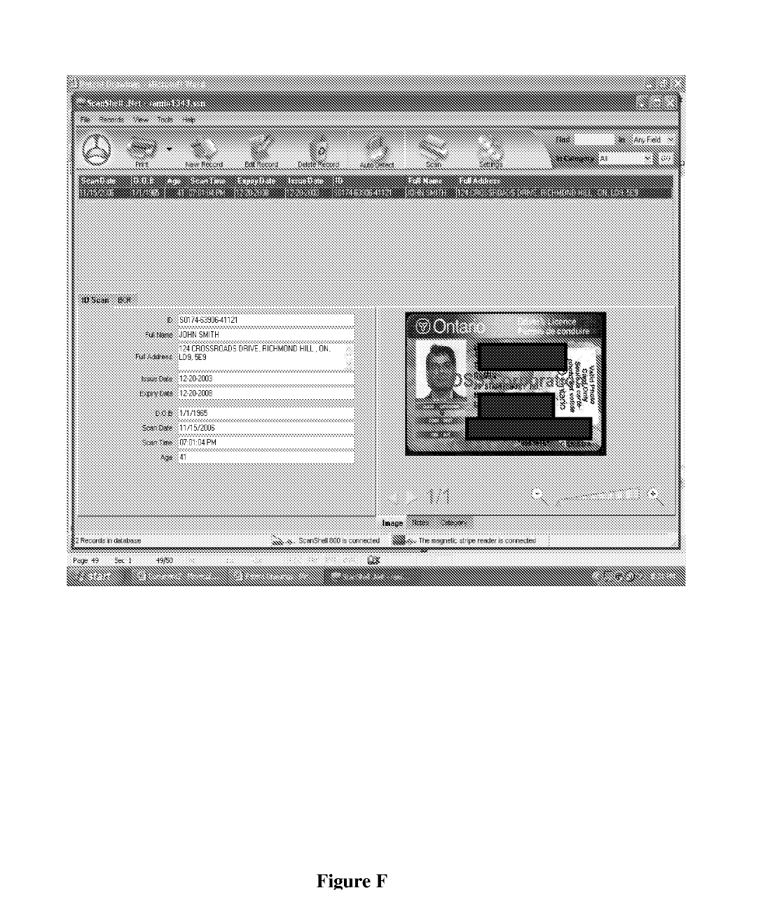

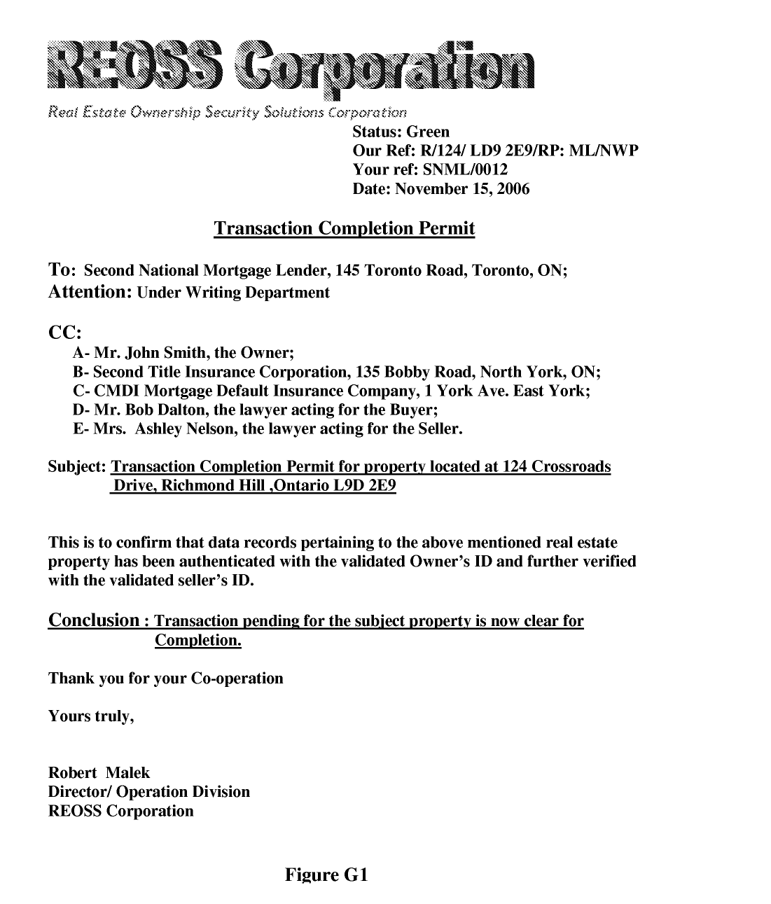

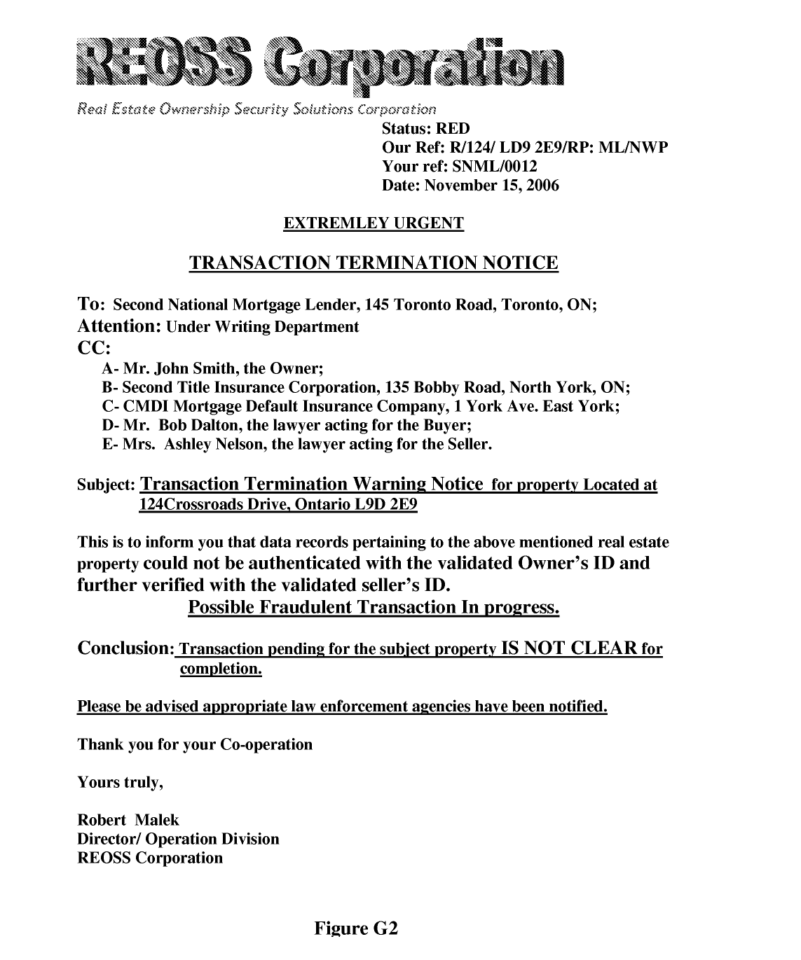

Once the validation of the selected second ID and confirmation of the inputted data from SIN/SSN card is obtained, the system then appoints the Validated ID as the 2nd set of validated ID reference data: VID2(n=24-26), Step (151) of FIG. C32 and the confirmed SIN/SSN card data as CID3(n=27-28), Step (164) FIG. 34.

b) An up-to-date credit history from owner(s)/Seller(s) to select the requested data as stated in Step (165) of FIG. C34. The credit history is obtained directly from EQUIFAX either by fax or on line. The user of the system then inputs and re inputs the selected data from Step (165) of FIG. (C34) and to further permit the system to execute the point out data confirmation algorithm Step (165 to 181) of FIGS. (C34 to 37) for errorless data entry in to the system.

Once the confirmation of data is obtained, the system further appoints the confirmed data as 4th confirmed ID data references:

CID4(n=29-32) as shown in Step (181b) of FIG. C37.

It is appreciated that at this stage the system has acquired all the necessary data records to initiate the authentication process.

The system executes the authentication algorithm as follow:

If driver's license was obtain as first ID, then Step (182) of FIG. C38:

Compare: VID1-21=VID2-24 &

VID1-22=VID2-25 &

VID1-23=VID2-26

Where as (VID1-21) represents the full name, (VID1-22) represents the address and (VID1-23) represents the date of birth of obtained from the owner(s)/seller(s) validated drivers license.

Respectfully (VID2-24) represents the full name, (VID2-25) represents the address and (VID2-26) represents the date of birth obtained from the owner(s)/seller(s) validated selected second ID card, stated in Step (134), of FIG. C29.

If hundred percent consistency is obtained in the compared then the system stores VID2 (24, 25 & 26) as confirmed and validated owner(S)/seller(s) of the designated real estate property to be applied in the next step of authentication process.

If the drivers License was not obtained as first piece of ID, then Step (183) of FIG. C38:

Compare: VID2-24=CID3-27=CID4-29 &

CID3-28=CID4-30 &

VID2-25=CID4-32 &

VID2-26=CID4-31

Whereas (VID2-24), (CID3-27) and (CID4-29) represents the full name from second ID stated in Step (134) of FIG. C29, SIN/SSN card Stated in Step (153) of FIG. C33 and up-to-date credit bureau report stated in Step (165) FIG. C34.

(CID3-28) & (CID4-30) represents SI/SS Number obtained from SIN/SSN card and an up-to-date credit bureau report.

(VID2-25) and (CID4-32) represents current address obtained from the selected second ID and an up-to-date credit bureau report.

(VID2-26) and (CID4-31) represents date of birth obtained from the selected second ID and an up-to-date credit bureau report.

If exact consistency is achieved, subsequently the system appoints VID2 (24,25 & 26) as confirmed and validated owner(S)/seller(s) ID data record: CVID(24,25 &26), step 184 of FIG. C38.

The authentication phase further includes the execution of consistency algorithm that ensures the comparability of the achieved confirmed data records—FIG. D1—in the data confirmation phase of the authentication stage.

The system executes the consistency algorithm as stated in Step 186 of FIG. C39:

Compare: CRD1-1=CRD2-10=CVID25 &

CRD1-2=CRD2-11 &

CRD1-3=CRD1-7=CRD2-12=CRD3-15 &

CVID24=CRD4-20 &

CRD1-4=CRD2-13 &

CRD1-5=CRD2-14=CRD4-18 &

CRD1-9=CRD4-19 &

CRD1-8=CRD3-17 &

CRD1 -6=CRD3-16

Where as:

CRD1-1: represents Municipality address from the 1st set of confirmed reference data, Step 55 of FIG. C13.

CRD2-10: represents Municipality address from the 2nd set of confirmed reference data, Step 85 of FIG. C19.

CVID25: represents current address of the owner(s)/seller(s) from confirmed validated Owner(s)/Seller(s) Identification card, Step 184 of FIG. C38.

CRD1-2: represents Legal description of the designated real estate property from the 1st set of confirmed reference data, Step 55 of FIG. C13.

CRD2-11: represents Legal description of the designated real estate property from the 2nd set of confirmed reference data, Step 85 of FIG. C19

CRD1-3: represents Transferor of the designated real estate property from the 1st set of confirmed reference data, Step 55 of FIG. C13

CRD1-7: represents mortgagor of the designated real estate property from 1st set of confirmed reference data, Step 55 of FIG. C13.

CRD2-12: represents Transferor of the designated real estate property from the 2nd set of confirmed reference data, Step 85 of FIG. C19.

CRD3-15: represents Transferor of the designated real estate property from the 3rd set of confirmed reference data, Step 106 of FIG. C23.

CVID24: represents full name of the owner(s)/seller(s) from confirmed validated Identification card, Step 184 of FIG. C38.

CRD4-20: represents beneficiary owner(s) of the designated real estate from the 4th set of reference data, Step 127 of FIG. C27.

CRD1-4: represents Transferee of the designated real estate property from 1st set of confirmed reference data, Step 55 of FIG. C13.

CRD2-13: represents Transferee of the designated real estate property from the 2nd set of confirmed reference data, Step 85 of FIG. C19.

CRD1-5: represents transfer date of the designated real estate property from 1st set of confirmed reference data, Step 55 of FIG. C13.

CRD2-14: represents transfer date of the designated real estate property from 1st set of confirmed reference data, Step 55 of FIG. C13.

CRD4-18: represents beneficiary owner(s) of the designated real estate from the 4th set of reference data, Step 127 of FIG. C27.

CRD1-9: represents consideration amount of the designated real estate property from 1st set of confirmed reference data, Step 55 of FIG. C13.

CRD4-19: represents beneficiary owner(s) of the designated real estate from the 4th set of reference data, Step 127 of FIG. C27.

CRD1-8: represents principle amount of the designated real estate property from 1st set of confirmed reference data, Step 55 of FIG. C13.

CRD3-17: represents the principle amount of the designated real estate property from the 3rd set of confirmed reference data, Step 106 of FIG. C23.

CRD1-6: represents Mortgagee/Chargee of the designated real estate property from 1st set of confirmed reference data, Step (55) of FIG. C13.

CRD3-16: represents Mortgagee/Chargee of the designated real estate property from the 3rd set of confirmed reference data, Step (106) of FIG. C19.

The execution of Step (263) of FIG. C38 marks the end of authentication process for the system.

It is necessary for the system to achieve exact consistency for data records in the comparability sequence stated hereinabove and illustrated in Step (186) of FIG. C39 to enable the system to engage the monitoring and protecting phase of the present invention.

### Monitoring and Protecting Process

In product of negative consistency of compared data records, the system will simuntansly display on the computer monitor and print all unmatched data records, Step (190) of FIG. C39.

The system further issues/relays warring notice to the parties involved in the transaction, e.g., Mortgage lenders mortgage default insurance, Title insurance, legal entities, FIG. G2.

At this stage the system has successfully prevented a possible fraudulent transaction from completion.

Respectfully the monitoring and protecting agency by implementing the present invention has effectively prevented a fraudulent transaction and precluded the associated extensive financial loses and lengthy/costly legal provocation to the involved Mortgage lender, Title insurance corporation and the Home owner(s).

In results of affirmative outcome of data records uniformity stated in Step 186 of FIG. C39, the system further appoint CRD1-1, CRD1-2, CRD1-6, CRD1-8, CRD4-19 and CRD4-20, as authenticated data records ADR(2,6,8,19&20) for the designated real estate Title (Ownership/Deed/Transfer), Step 187 of FIG. C39.

The system next stores the mentioned authenticated data records in to a computer data base, illustration 1 of figure A in a predefined format, FIG. D6 which is simuntansly displayed in the computer monitor. Also a printable version for hard copy filing is an available option to the system user.

The system user, by selecting the owner as the requesting origin of the authentication process for the designated real estate property directs the system to prepare:

a) And transmit a monitoring and protection registration template, Step 197 of FIG. C40, as protected real estate Title addressed to all mortgage lenders and private financial institute, Title Insurance Corporation and mortgage default insurance companies available in mortgage and Title insurance national database.

b) And register Second mortgage as security mortgage/charge using authenticated data records stored in the system database, FIG. D6 and Step (195) of FIG. C40 on the authenticated Title either on line where permitted e.g., TARANET system in province of Ontario, Canada or manually in the local land registry office.
b) And issue Transaction Permit user name as TPUN and security code as TPSC, FIG. F5 and Step (196) of FIG. C40 for validated owner and the related file for the designated authenticated real estate Title.

At this phase of the monitoring and protecting stage of the present invention, the system has engaged into an active protection mode for the authenticated designated real estate Title.

It is appreciated that at this stage of the present invention any new or pending transactions requested by any third party for the protected designated real estate Title must obtain transaction clearance from the monitoring and protecting agency before being practically able and permitted to complete the transaction.

The system user by inputting transaction request for the protected designated real estate title engages the system into the verification process.

Verification process

The system further executes the verification process by:

a) Obtaining transactional data records equivalent to ADR1, ADR2, ADR6, ADR8, ADR19, CVID24, CVID26, CVID28 Transaction User Name and Password from the transaction requesting party(s), Step (199 ) of FIG. C41.

b) Obtaining business information and contact name of mortgage lender, mortgage default insurance, if applicable, Title insurance company and legal entities for buyer and seller relevant to the requested transaction, Step (205) of FIG. C42.

c) Appoint the obtained equivalent Transactional data as RPTD (1,2,6,8,19), personal identification information of the requesting party as RPID(24,26,28), Transaction permit user name as RPTPUN and Transaction permit security code as RPTPSC, Step (200) of FIG. C41.

d) Executes the consistency algorithm Step (199) of FIG. C41 as follow ADR1=RPTD1, CRD1-2=RPTD2, CRD1-6=RPTD6, CRD1-8=RPTD8, CRD4-19=RPTD19, TPUN=RPTPUN and TPSC=RPTPSC.

In the product of achieving exact consistency result for above compared data records, the system will reach the Transaction completion stage.

The system executes the Transaction Completion process by:

a) To prepare and communicate transaction permit to all relevant parties engaged in the completion of the transaction, Step (206) of FIG. C41.

b) To Prepare discharge documents for the security Charge/Mortgage registered on the Title of the protected designated real estate Title (Deed/Transfer/ownership), Step 207 of FIG. C43.

C) To Discharge the security Charge/Mortgage from the Title of the protected designated real estate Title (Deed/Transfer/ownership), Step (208) of FIG. C43.

The system user by selecting Transaction instead of owner, Step (189a) of FIG. C39 as the requesting origin of the authentication process for the designated real estate property, directs the system to obtain:

a) Requesting party(s) information. e.g., name, Address, Tel, Fax, email, nature of request, nature of Business (i.e. Mortgage lender, Title insurance, Mortgage default insurance, Lawyer, Real estate broker, or Law enforcement agencies.)

The system by receiving requesting party's(s) information, it prepares and conveys Transaction permit for completion, FIG. G1, to all parties relevant to the transaction of the authenticated designated real estate property, Steps 209,210&211 of FIG. C43.

It appreciated that at this stage, the present invention has successfully and effectively engaged in to a process by means of method and system to authenticate, monitor, protect and complete a genuine and lawful real estate transaction and simuntansly has prevented a fraudulent transaction on a real estate Title with the associated subsequent financial damages and lengthy/costly legal aggravation to parties involved in the transaction and real estate industry in broader-spectrum.

Although the detailed description of the present invention have been described with respect to the referenced drawing, but it is to be understood that the invention is not limited to the described embodiments and other changes alteration and modification could be made by ones aptitude in the related art without departing from the function, scope and the essence of this invention.

The Entitlement to the Exclusive Property & Privilege of the present invention are claimed as follow:

1. A method for monitoring and protecting a designated real estate Title (Deed/Transfer) against title theft, fraudulent transaction, mortgage fraud and illegal activity from unauthorized party, comprising the process and steps of:
a) Compiling selected data records associated with a designated real estate Title (Deed/Transfer) from plurality of predefined sources and storing the compiled selected data within a computer database;
b) Number referencing stored selected data to further facilitate the authentication process with owner/seller's Title (Deed/Transfer), Mortgage/charge, Tax statement documents and validated owner/seller's personal Identification information;
c) Assign owner/seller transaction permit code to an authenticated Title,
d) Produce and issue security charge registration document derived from the said authenticated selected data record;
e) Register produced security charge for an authenticated designated real estate Title(Deed/Transfer);
f) Monitor an authenticated real estate title by registering the said Title with local and national lender data base, Mortgage default insurers and Title insurance companies as protected Title;
g) Protecting an authenticated designated real estate Title from fraudulent transaction, mortgage fraud and illegal activity by further implementing the verification of personal information and transactional data of the transaction requesting party with authenticated data records available for the protected Title,
h) Stop transaction in detection of informational and data discrepancies by notifying legal entity acting on transaction and related law enforcement agencies of fraudulent status of transaction;
i) Issue transaction completion permit and produce discharge documents for the said registered security charge.

2. The method according to claim 1, Wherein said process for collecting selected data records from plurality of different sources related to a designated real estate property and storing the said collected data records into a computer database further includes steps using data records registered in the land registry office (system) as first set of data records.

3. The method according to claim 1, which further comprises of steps to reference number first set of data records using reference numbering algorithm.

4. The method according to claim 3, wherein said reference numbering algorithm which further comprises of steps to reference number each selected data record in the first set of data records.

5. The method according to claim 4, which further comprises the use of Municipality address, Legal Description, Transferor, Transferee, Transfer date, Mortgagee, Mortgagor, Mortgage Principle amount and Consideration amount registered in the Land registry office (system) for a designated real estate property as the 1^{st}, 2^{nd}, 3^{rd} 4^{th}, 5^{th}, 6^{th}, 7^{th}, 8^{th} and 9^{th} reference data.

6. The method according to claim 1, wherein said process for collecting data records related to the designated real estate property and reference numbering the said complied data records includes further steps of using data records registered in the owner/seller Title (Deed/Transfer), Mortgage/Charge, Land Transfer Tax and document for the designated real property as the second, Third and Fourth set of references data.

7. The method according to claim 6, wherein said reference numbering second, third and fourth set of data records which further comprises of reference numbering algorithm.

8. The method according to claim 7, Wherein said reference numbering algorithm further includes using steps to reference number each selected data record in the second, third and fourth set of data records.

9. The method according to claim 8, which further comprises the use of Municipality address, Legal Description, Transferor, Transferee and Transfer date, Mortgagee, Mortgagor, Principle amount, Receipt date, Consideration amount and Beneficiary owner registered in the owner/seller's Title (Deed/Transfer), Mortgage/Charge and Land Transfer Tax documents of the designated real estate property as the 10^{th}, 11^{th}, 12^{th}, 13^{th},14^{th}, 15^{th}, 16^{th}, 17^{th}, 18^{th}, 19^{th} and 20^{th} reference data.

10. The method according to claim 1, Wherein said validation of the owner(s)/seller(s)'s identification information includes further steps of collecting selected data from 2 piece picture ID document.

11. The method according to claim 10, which further comprises of steps of selecting drivers license as the fixed component of the 2 piece picture ID document and Passport, Immigration card or Health card as the second piece picture Id document.

12. The method according to claim 11, further includes steps of collecting selected data from 2 piece picture ID document and SI/SS card further includes steps for reference numbering selected data.

13. The method according to claim 12, wherein said reference numbering selected data further includes reference data numbering algorithm.

14. The method according to claim 13, further includes steps of using drivers license in a swipe card technology to validate data on a drivers license.

15. The method according to claim 14, wherein said drivers license validated data are further appointed as:
a. Name as 21^{st} data.
b. Address as 22^{nd} reference data.
c. Date of birth as 23^{rd} reference data.

16. The method according to claim 15, Wherein said reference numbering algorithm using data in the selected second ID document mentioned in claim 36 further appoints:
a. Name as 24^{th} second reference data.
d. Address as 25^{th} reference data.
e. Date of birth as 26^{th} reference data.

17. The method according to claim 16, which further comprises the use of name and Social Insurance/Security Number on owner/seller(s)'s SIN card as 27^{th}, and 28^{th} reference data.

18. The method according to claim 17, Wherein said comparing selected reference numbered data to further assist the validation process of owner/seller(s)'s personal identification data.

19. The method according to claim 18, Wherein said validation process of owner/seller personal identification data further includes validation algorithm.

20. The method according to claim 19, Wherein said validation of Owner's/Sellers Identification data further includes validation algorithm comprises of steps for comparing 17^{th}, 18^{th} and 129^{th} reference data with 20^{th}, 21^{st}, and 22^{nd} second reference data for determination of exact consistency.

21. The method according to claim 11, which further comprises the use of selected data records from an up to date credit bureau report in circumstance of non-availability of drivers license.

22. The method according to claim 21, which further comprises the use of Name, Social (Insurance/Security) number, Date of birth and Latest address in credit report as 29^{th}, 30^{th} 31^{st} and 32^{nd} reference data.

23. The method according to claim 22, Wherein said validation of Owner's/Sellers Identification data further includes validation algorithm comprises of steps for comparing 29^{th}, 25^{th}, 30^{th} and 31^{st} reference data with 24^{th} & 27^{th}, 32^{nd}, 28^{th} and 26^{th} data for determination of exact consistency.

24. The method according to claim 23, wherein said owner(s)/seller(s) validated personal information are copied and stored into a computer database as owner/seller's valid personal data.

25. The method according to claim 1, wherein authentication process further includes authentication algorithm.

26. The method according to claim 25, wherein said authentication algorithm further includes steps to compare reference data 1,10 & 25; 2 & 11; 3, 7, 12, 15, 24 & 20; 4 &13; 5, 14 & 18; 8 & 17; 6 & 16 for determination of exact consistency

27. The method according to claim 26, which further comprises of steps to appoint reference data 1, 2, 6, 8, 19 & 20 as authenticated real estate title (Deed/transfer) data records.

28. The method according to claim 27, which further comprises of steps for assigning a Transaction permit serial number and security code to an authenticated real estate Title (Deed/transfer).

29. The method according to claim 28, wherein said authenticated real estate title (Deed/transfer) data records and assigned transaction permit code are copied and stored into an associated file in computer Database.

30. The method according to claim 29, which further comprises of steps for issuing a security Charge/Mortgage document for an authenticated real estate Title (Deed/Transfer).

31. The method according to claim 1, which further comprises of steps for monitoring an authenticated real estate Title (Deed/Transfer) by registering the said Title with the national database for mortgage lenders, mortgage default insurance corporations and title insurance companies.

32. The method according to claim 30, which further comprises of steps of protecting an authenticated designated real estate Title (Deed/Transfer) by registering the security charge on the authenticated Title (Deed/Transfer).

33. The method according to claim 1, which further comprises of steps for protecting an authenticated real estate title (Deed/Transfer) by verifying the personal and transactional data of the transaction requesting party with the authenticated data available for the said Title (Deed/Transfer) available in the database.

34. The method according to claim 33, wherein said verification of personal and transactional data of the requesting party further includes verification algorithm.

35. The method according to claim 34, wherein said verification algorithm further compares obtained transactional data and assigned permit code with authenticated data records stored in the database to determine precise consistency.

36. The method according to claim 35, further includes steps for issuing a transaction permit to the legal entity(s), the lender/mortgage corporation and title insurance provider acting on the transaction.

37. The method according to claims 35, which further comprises of step to terminate the transaction in determination of inconsistency of compared data in verification process.

38. The method according to claim 37, which further comprises of step for issuing transaction termination warning to the Legal entity, Lender/mortgage corporation and Title insurance company acting on the transaction and the related law enforcement authorities of the fraudulent status of the transaction.

39. The system according to claim 1, wherein using validation, authentication and verification algorithm for comparing information obtained from selected data record related to a designated real estate title (Ownership/Deed/Transfer) from plurality of predefined sources for the purpose of validation, authentication and verification process.

40. The system according to claim 1, Wherein the system further includes a computer database for storing selected data records related to a designated real estate Title(Deed/Transfer) and a computer software to number reference the said data records, execute the said validation authentication and verification algorithm and populate the authenticated and verified information into a predefine file format as transaction completion permit, security charge registration, security discharge documents and transaction termination warring.

41. The system according to claim 1, Wherein said stored data records, reference numbered data, validated, authenticated, verified data are stored in a databases are viewable in a predefined format using standard computer monitor and printable copy for hard copy record keeping.
